(19) United States
(12) Patent Application Publication
(10) Pub. No.: US 2017/0137116 A1
(43) Pub. Date: May 18, 2017

(54) EFFICIENCY IMPROVEMENTS FOR FLOW CONTROL BODY AND SYSTEM SHOCKS

(71) Applicants: Peter Ireland, Wentworth Falls, NSW 2782 (AU); Anthony Ireland, Lynn Haven, FL (US)

(72) Inventors: Peter Ireland, Wentworth Falls, NSW 2782 (AU); Anthony Ireland, Lynn Haven, FL (US)

(21) Appl. No.: 15/319,807

(22) PCT Filed: Jun. 24, 2014
(86) PCT No.: PCT/IB2014/062549

§ 371 Date: Dec. 19, 2016

(51) Int. Cl. B64C 23/06; B64C 21/10; F04D 29/32; F01D 9/02; F23R 3/00; F04D 27/00; F01D 5/14; B64F 5/60; F04D 29/54

(52) U.S. Cl. CPC B64C 23/06; B64F 5/60; B64C 21/10; F04D 29/324; F04D 29/542; F04D 29/545; F23R 3/002; F04D 27/009; F01D 5/147; F01D 9/02; B64C 2230/26

(57) ABSTRACT

Methods and related apparatus embodiments are disclosed that allow novel Conformal Vortex Generator and/or Elastomeric Vortex Generator art to improve energy efficiency and control capabilities at many surface points of a body or object moving at speed in aero/hydrodynamic Newtonian fluids, by reducing; shock energy losses, surface flow turbulence, and/or momentum layer thicknesses.

### CROSS-REFERENCE TO RELATED APPLICATIONS

This application is a continuation-in-part of International application PCT/IB 13/50676 filed 25 Jan. 2013, which is a continuation-in-part of US National stage application US2011/0006165A1 filed Jul. 8, 2010, which is the non-provisional application derived from provisional U.S. application 61/224,481 filed Jul. 10, 2009, also filed as International application PCT/IB2010/001885 on Jul. 9, 2010. This application is filed prior to publishing of parent PCT/IB 13/50676, and incorporates by reference all earlier applications, and hence is limited by parent applications in a terminal disclaimer condition as required.

### BACKGROUND OF THE INVENTION

Field of the Invention

This invention is in the field of improving; shock losses, and/or flow losses from normal or oblique Shock Boundary Layer Interaction (SBLI) or Shock Wave Boundary Layer Interaction (SWBLI), in addition to control of flow separation and turbulent flow losses, on the fluid-flow modifying or controlling surfaces of bodies in motion by embodying new art aero/hydrodynamic structure embodiments and methods disclosed herein.

Description of Related Art

Shocks have profound impacts and consequences for high speed fluid flows and flight. Computer Fluid Dynamics (CFD) modelling taught for the e.g. Embraer EMB170 Regional Jet type wing at e.g. Mach 0.82/Flight Level 350 cruise shows the normal-shock foot location and SBLI (or Lambda-foot) falls at about 75-85% chord, (i.e. rearwards) as would be expected with this wing's supercritical foil aerodynamic intent. By contrast direct shadowgraph imaging in flight of the SBLI location of an EMB170 wing at cruise shows the shock location to be actually at ˜25-30% of chord, or significantly further forward, and hence giving impaired Natural Laminar Flow (NLF) extent and thus increased drag over the design expectations. Non-coherent light shadowgraph imaging by eye or camera is possible in some circumstances because the intense shock foot modifies local air density and optical refractive index, so grazing angle illumination and viewing through the shock foot volume can generate visible differences in surface brightness due to selective refraction. The effect of a Slat flow discontinuity is to cause a significant impairment to a wing operating in; shock and compressibility effects and designed for optimal NLF flow intent. It is not clear that any significant prior art work has recognized the significance of this issue, or that work has been performed to adequately address or mitigate this Slat flow-discontinuity aerodynamic performance-limiting issue.

Aircraft of all sizes usually employ wing leading edge (LE) Slat and/or trailing edge (TE) flap lift-enhancing systems that increase wing camber and Coefficient of Lift (C_{L}) and thus allow lower takeoff and landing speeds, whilst allowing most compact and drag efficient cruise configurations. This is the case for both swept and un-swept wings. Wings and foils are in fact a fluid-flow modifying or control device that generate lift and drag by circulation and hence vortex action. Extended LE Slats are configured to have beneficial deployed effects at low airspeed and high Angle of Attack (AoA) by enhancing the wing C_{L}. Extended Slats form a LE slot configuration that accelerates some incoming freestream airflow portion (or fluid-flow) from the lower wing pressure-face up over the top suction-face, which increases the suction-face lift, and also acts to lower suction face susceptibility to flow separation or wing stall at low airspeed and/or high AoA.

Following on from earlier disclosed art, a new inventive effort was undertaken to address these fluid-flow disturbance problems, and the novel new art and unexpected beneficial outcomes of utility are disclosed herein.

Some Airbus A-330 aircraft have employed spanwise ridges of material applied to the wing at the Slat TE in an apparent attempt to control and/or seal the Slat gaps. This may have some small beneficial effects at cruise conditions, but with extended Slats in low speed conditions, a spanwise step/discontinuity remains at the aft position of the Slat slot in a high speed accelerated fluid-flow. This spanwise AFS configuration is known to increase drag on an airfoil, as taught by e.g. Calvert et al. from the US Army Redstone Arsenal AIAA paper titled “Aerodynamic Impacts of Helicopter Erosion Coatings”, and this drag increase occurs at the point an aircraft is most sensitive or vulnerable to; drag, engine power limitations, and is close to the ground. Sealing of e.g. aileron gaps on high performance aircraft like sailplanes is known to reduce inflows from underside pressure surfaces and improve the aerodynamics and fluid-flows on the upper wing suction surfaces.

Abbot (a former NASA Director) and von Doenhoff as early as 1949, in the book “Theory of Wing Sections” point out on e.g. page 227, that to minimize wing cruising Coefficient of Drag (C_{D}) it is beneficial to close any slot between a LE Slat and a following wing. This ensures no airflow passes through to disturb the cruising wing suction-face fluid-flow dynamics, which is typically held as a laminar flow as long as possible to provide a low C_{D}.

In the cruise condition with a fully-closed or sealed LE Slat slot, it is desirable that no pressure-face air will infiltrate up to the suction-face to disturb and/or thicken the wing Boundary Layer (BL) into premature Transition or Turbulent flow. A practical Slat device has a finite TE thickness (or TE radius) that may then touch the wing at a tangential coincidence, but this finite height step represents a spanwise surface discontinuity of an aft-facing step (AFS) or valley feature that will then also affect or trip the incoming LE initial BL Laminar flow into an early Transitional or Turbulent flow onto the following surface. Practical, manufacturable and maintainable Slat TE thicknesses are in the approximate millimeter-plus range (blunt radius), and on an e.g. Mach 0.82 transonic swept wing aircraft the LE BL thicknesses may only be just tens to hundreds of microns thick. Thus a stowed Slat represents a device of significant dimension offset or AFS to the fluid-flows, and that can tend to upset the wing's forward section laminar BL flows, as desired by modern low drag and high speed wing airfoils.

The Slat is a structure that extends or deploys from the wing with discrete attachments, different geometry and air-loads and so it cannot exactly mimic the deflections and distortions of the wing in service, or over time. For this reason a visibly non-uniform Slat TE to wing gap is apparent in the Slat stowed or cruise condition, and this means that a gap-seal such as a typical 5 to 20 mm transverse block or cylinder of compliant material is used to seal this gap over a range of dimensions, tolerances and Slat sizes. Non-uniform contact rub-marks on the wing surface under the Slats and “oil-canning” distortion of the wing panel sheets after a history of many stress load cycles show the Slat gaps cannot be easily controlled or sealed just by close tolerance fit when retracted. This varying Slat location and/or interference fit also causes damage to the anti-friction paint protecting the wing surface from rubbing and corrosion, so maintenance requires continuous repair of this protective coating on the wing. If the necessary Slat gap seals are damaged that can cause several percent increase in cruise drag. The Slat seals are typically placed along the rear inside face of the Slat, and this means that there is the possibility of extra induced spanwise turbulence and drag loss induced in the slot flows when the Slats are extended at lower speeds.

At the cruise high-speed and hence low operating AoA condition, retracted Slats also have profound adverse effects on the wing LE laminar flows, and can disrupt these as a spanwise flow discontinuity, so as to increase flow Turbulent Kinetic Energy (TKE), drag and lower energy efficiency and/or raise aircraft fuel consumption and/or increase carbon dioxide emissions.

The Piaggio P180 Avanti is an efficient twin-engine pusher turboprop designed for fuel efficient high speed cruise. It employs some pressure-face foil reflex camber in the aft chord area. This is typical of a “supercritical” low-drag foil like taught by Whitcomb in U.S. Pat. No. 3,952,971 or a similar foil like Noonan U.S. Pat. No. 4,776,531. These aft-loaded foil designs enable the suction-face pressure recovery location, and any possible associated sonic flow-deceleration normal-shock SBLI, to occur further back on the foil chord; enabling an extended forward section of BL NLF which promotes a significantly lower TKE and BL drag component at typical cruise speeds.

Accumulated paint damage, debris/dirt or insect impacts on the P180 wing LE surface force immediate and early premature BL transition from Laminar to Transitional to Turbulent flow, increasing drag and negating the possibility and advantages of the NLF design intent for the downstream wing surface. This effect can cause a sufficiently severe increase in drag that single engine operation is compromised; where maintaining altitude at maximum P180 aircraft weight may be a problem on a single engine.

To mitigate this performance degradation a 100 mm section of erosion protection system (EPS) tape ˜0.35 mm thick is typically placed symmetrically along the span of the P180 wing LE to stop erosion damage. This solves the erosion issue but immediately causes an increase in drag and reduction of the wing Lift to Drag (L/D) ratio at a cruise speed of ˜390 knots True air speed (TAS) or ˜M0.65. This result is exactly analogous to the L/D and BL flow disturbance of an LE Slat flow-discontinuity. The P180 does not have Slats, but a spanwise LE EPS tape effectively provides a retracted Slat TE emulation on this wing. The loss of performance at this speed; for the same power settings and fuel flows is in the order of ˜20 knot speed reduction. This additionally confirms a Slat TE type discontinuity has profound adverse effects on the following BL. In terms of wing section L/D this change in performance is significant inherent efficiency degradation by prior art LE high lift devices, and any other unintentional spanwise step or trench like flow disturbances like surface joints.

The high sweep-angle “Waverider” type of conical and/or semi-cylindrical lifting body is often employed for high speed flight, and these may employ lower surface dynamic pressure for generating lift at high speed. At low speeds, e.g. like a landing approach, this form may approximate a delta wing, where very intense bound Leading Edge (LE) upper surface suction-face edge vortices are employed to generate significant slender delta vortex lift. In some geometries added suction-face lift from improved upper suction-face flows from a modified LE Slat or similar type of fluid-flow passing slot arrangement (between the LE edge vortices) would be useful as a lift performance improvement, and mitigate significant operational handling difficulties associated with vorticity asymmetry at high AoA which result in yaw divergence, roll excursion and departure from controlled flight.

Additionally these high performance vehicles may suffer from other fluid-flow separation and control problems on other fluid-flow surfaces and ducts that may also be mitigated by these disclosed novel vortex generator shock control strategies. Flow control methods employing elastomeric and/or other material vortex generating devices and in novel combinations can be employed to mitigate these problems.

Vijgen in U.S. Pat. No. 5,088,665 teaches an art of Trailing Edge (TE) serrations on a rigid panel that are employed to inject freestream vortices streaming into a trailing freestream wing-wake flow to “ . . . reduce drag and improve lift . . . ”. Vijgen'665 does not teach generating and then releasing these streaming vortices directly onto a flow control or foil surface, wholly before the TE and below the sub-boundary layer of a fixed downstream trailing aero/hydrodynamic surface. The CVG is generating uniquely beneficial vorticity that is acting outwards from the actual foil surface below the sub-BL, through this sub-BL and to some extent into the further out Laminar BL and/or then Turbulent BL layers. Vijgen'665 FIG. 10 teaches a wing and wing-flap with TE serrations but does not teach a leading edge Slat and slot mechanism employing TE serrations. Vijgen'665 does not teach TE serrations that seal or abut directly against a following aero/hydrodynamic surface structure to generate sub-boundary layer streamwise counter-rotating vortices that can be configured to avoid an adverse spanwise transition vortex when two foil surfaces are in close proximity without smooth surface continuity and sealing.

Vijgen'665 does not teach the use of flexible and/or mechanically compliant materials e.g. elastomeric materials, at the TE location to seal or bridge across a gap between airfoils, or avoiding adverse; addition of TE masses, reduction of fluid-flow flutter-margins, aeroelastic loadings and material fatigue on the thin TE structures.

A retracted Slat with Vijgen'665 rigid TE serrations (not actually taught by Vijgen) is not an optimal or functional configuration when overlapping the forward LE section of the following main wing. This is because any Slat TE vortices cost energy to be generated and are induced a slot gap above the following wing foil BL and cannot then attach directly on the following surface or sub-BL to directly improve the following wing BL drag structure or stall AoA, which is typically the largest lifting and drag inducing surface area. A retracted LE Slat with inflexible Vijgen'665 TE serrations will massively upset or trip the forward section of BL laminar flow for the following wing section because the Slat is typically thick at the TE with a relatively blunt aft-facing round edge for maintenance safety and a TE angled step-cut will decrease in height rearwards, and that is known to be adverse to; generating persistent sub-BL vorticity in the freestream direction which will then attach or “bond” closely down onto to downstream surfaces, submerged below the local BL. Vijgen'665 Column 1/line59 states that a Gurney Flap (or tab) “ . . . does not reduce drag for a given amount of lift.” This is directly contradicted by the new art employing an offset elastomeric Lift Enhancing Tab (eLET) and CVG in combination that on a real flying aircraft provides a large reduction in drag at the same aircraft weight or lift condition at the climb and/or cruise. This clearly distinguishes the new art from the stated Vijgen'665 prior art.

Balzer in U.S. Pat. No. 6,612,106 teaches a TE serration configured to create freestream vortices that improve flow mixing and reduce low frequency noise, but are known to definitively increase drag on e.g. Boeing 787 and 747-800's when employed on engine nacelles to lower noise signatures, so the latest Boeing nacelle designs have stopped using these structures. Bender in US2008/0217484 teaches a trailing edge serration to generate freestream vortices, like Vijgen '665, but does not claim any noise reduction, and in fact was abandoned.

Henne in U.S. Pat. No. 5,322,246 teaches an anti-icing device that develops intentional and functional downstream high turbulence on a wing foil with a well-known “Turbulator” type structure, for the purpose of breaking up ice melt flow-back water so it cannot cause re-freezing problems downstream on e.g. TE control surfaces. Henne '246 does not teach or claim his new art is capable of; (a) developing intense sub-BL streaming vortex-pair filaments attached onto the following foil surface in the freestream direction, and/or that these vortices are effective in reducing shock and wave-drag losses in a following SBLI Lambda-foot disturbance, or (b) that the Henne '246 art is capable of inducing any downstream thinned momentum layer (termed re-laminarizing herein) in the BL flows which also lowers drag by reducing BL turbulence and eddy losses etc.

Henne is an acknowledged expert in the art of aerodynamics, with demonstrated “above ordinary skills”. Since 1991 many thousands of new-design civil transport and other aircraft have been manufactured, and none of these appear to have adopted this Henne '246 anti-icing turbulator embodiment. This is clearly because anti-ice fluid systems, bleed-air or electrically heated Slats and/or LE surfaces adequately de-frost/ice these LE surfaces before any significant droplets form and amalgamate, and in fact natural downstream wing BL turbulence tends to dissipate any rear-streaming water droplets off the foil naturally. So in this case, adding a Henne '246 Turbulator structure (that has been proven to increase drag on a transonic foil in direct contrast to a CVG outcome) makes no economic sense, since it is effectively a drag increasing partial speed-brake that cannot ever be retracted.

Relying on similitude to evaluate “similar looking prior art” can be ineffective and misleading and is an invalid scientific or physics method and practice. For example Whitcomb '971 and Noonan '531 art both teach extended laminar BL region aft-loaded foils with only ‘minor dimension differences’, and yet they have patently distinct outcomes and utility not visible by mere inspection of dimensions. In many cases utility and differences may only be truly discerned by evaluation of functional outcomes.

In the modern technological world there are numerous examples of fundamental and valuable patented new-art that differ a seemingly very small amount merely in; a “dimension”, an “angle” or a “composition of material” or matter.

For example, the Esaki Tunnel Diode employs a semiconductor junction configuration that when forward-biased enters an unexpected but valuable “negative resistance” regime that is useful at e.g. microwave frequencies. This is due to quantum mechanical (QM) tunneling of charge carriers through a seeming classically “impossible dimensional and energy barrier”. In this case the QM effect is strongly affected by the non-zero evanescent decay rate of the charge carrier particle's wavefunction (probabilistic distribution), so the effective dimensions of the junction “barrier” are critical to correct operation. A small fabrication change of junction dimension destroys QM tunneling capability, so researcher may only stumble on this wholly novel effect by “merely a dimensional change”.

For the ubiquitous and e.g. original cavity-pumped ruby lasers, the optical cavity used to provide high Q for lasing gain and mode purity is a parallel plate interferometer that tunes a specific laser cavity mode, and if this suffers a small angular deviation from an exactly parallel interferometer mirror configuration, this proper operation mode is degraded, suppressed or inoperative.

Modern group IV semiconductor materials employ a minute trace of diffused dopant atoms to radically modify internal band-gap levels and make semiconductor structures possible; so a simple “minor change in/of materials” or composition/dimensions of matter makes a profound novel functional capability possible. This novel CVG and eLET art have some similarities, in that small or subtle but profound changes to seemingly similar mundane arrangements, dimensions and compositions of matter can have unexpected and profound new physics capabilities and valuable and unexpected embodiment outcomes and utility over any prior art.

McVeigh in U.S. Pat. No. 7,748,958 teaches the use of e.g. drag inducing blade-type VGs on a rotor blade to delay flow-separation and hence reduce the dynamic blade-pitching moment (Cm) and hence cyclic mechanical stresses on the rotor system and then airframe. Drag reduction over baseline drag for AoA angles below the baseline unmodified blade stall AoA is not taught or claimed nor is possible by McVeigh's art device. So this McVeigh '958 art does not perform as CVGs can, by reducing blade drag at low positive or negative, or zero AoA angles, below the baseline stall AoA. At and above nominal foil stall angles CVG's perform better than any prior art VG. This is particularly true for VG's employed in the highest velocity tip regions.

Martin and McVeigh et al. in a 2008 AIAA paper “Passive Control of Compressible Dynamic Stall” in FIG. 23 teach that stall AoA and dynamic-stall foil Cm and Cm peak excursion and hysteretic-cycle blade-flutter inducing imbalance is improved on a VR-7 helicopter blade foil using VGs. However FIG. 27 teaches the C_{D} increases from C_{D}=˜0.01 to C_{D}=˜0.015, a ˜+50% increase in foil power requirement for flight in non-rotating (i.e. non-radially accelerated) pitching case, as this test was conducted.

The significant additional increases of drag in the foil rotating case is seen in all research over the last half-century for all prior-art VGs, before the advent of new art CVGs, which clearly do not exhibit this rotating-foil environment C_{D} drag-rise problem. McVeigh '958 and the Martin and McVeigh et al. paper teach a reduction in foil Cm, but McVeigh '958 does not teach that the prior art VGs cannot be deployed e.g. outboard of 50% of span in the rotating case before additional drag becomes prohibitive and unacceptable.

Shivers teaches a similar adverse drag outcome for rotating foils in a 1960 NASA D-376 Technical Note entitled “High-tip-speed static-thrust tests of a rotor having Naca 63/(215) A018 airfoil sections with and without vortex generators installed” teaches for a VG installed on a rotating helicopter blade “ . . . that the profile torque was increased prohibitively . . . ”, while blade-tufting showed that stalling AoA was improved as was expected.

Vestas Wind turbine blade designs, typified by Godsk in U.S. Pat. No. 7,914,259, teach employing several rows of discrete prior art VGs along wind turbine blades to extend baseline unstalled AoA from about 10 degrees, to about 16 degrees with VGs added, as shown by his FIG. 3. The well-known AoA curves have a constant “A-slope” characteristic, so extending the AoA at stall also extends the maximum C_{L} by a proportional amount (and blade torque change, dQ), as well-known to those practicing the art of fluid-flows and foil designs.

The Godsk '259 FIG. 4 also confirms the severe problem with all prior art discrete ramp and blade VGs on a rotating component or environment, that at low AoA, and up to about 8-10 degree baseline stall AoA, the VG equipped blade has and almost 100% higher C_{D} than a baseline unmodified blade. This is a huge problem for lift-generating foils like compressors, fans, pumps, rotors, propellers, wings and the like, because of increased energy inputs, torque or C_{D} drag energy cost. This may typically be not so critical when extracting power from a fluid-flow, like a wind turbine blade or a jet engine or steam turbine blade. Any extra turbine C_{D} drag cost will lower energy extraction efficiency, increase stagnation pressure losses, and the drag vector acts to increase any blade bending moments and mechanical stress.

A CVG placed at the blade foil chord location of any VG (or micro-VG, uVG) devices as taught by Godsk '259 clearly do not operate like these prior art devices, but provide a contrasting and unexpected outcome of being a drag-reducing device able to reduce C_{D}, improve C_{L} above the baseline blade stall AoA and may also provide an LE EPS system. A CVG can be applied to this wind turbine blade to provide an EPS capability without reading into the Godsk '259 claims, since a CVG is configured by the BL thickness, not strictly chord size and is typically less than the lower limit claimed 0.1% chord size, and is efficiently applied as only a single row of VG generators so as to avoid a higher C_{D} or drag increase that Godsk '259 clearly suffers from.

The new art ‘CVG’ and e.g. Godsk ‘VG’ names both share combinations of the root words “vortex” and “generator” but however have distinctly different outcomes when applied on a blade, foil or flow control surface. For this and many other reasons a CVG is not simply a sub-set or variation of any prior-art VG by ‘name-association’, but a distinctly separate class of functional fluid-flow control device (like an e.g. Riblet) which is not anticipated by Godsk '259 or any other prior-art combination.

Riblets are also an aerodynamically unique prior art with their micro-scale streamwise grooves that are understood as tending to re-organize the lowest levels of an incoherent and high TKE Turbulent BL from significant spanwise eddy fragments and hairpin vortices into a more organized and lower loss more-streamwise eddy fragment flow. Riblets are the only other known fluid-flow control device that can lower a surface form or pressure drag by ˜−3 to −10% on a foil without flow separation bubbles, besides the CVG. However the CVG and Riblet are distinctly different in their operative physics mechanisms and overall effect; and only the CVG effectively exhibits passive BL suction. Additionally the Riblet is effective only where applied and so requires large area coverage with concomitant large mass addition for useful benefits, but the energy cost to transport this added mass largely negates any useful outcome. By contrast CVG's are inherently a localized and low mass application device with broad beneficial effects on the surrounding fluid-flow control surfaces.

Considering the unique CVG operative combination of streaming v-tip vortices and effectively re-laminarized BL between the downstream v-tips, it is clear that a CVG effectively delivers on the promise of the Laminar Flow Control (LFC) or Hybrid Laminar Flow Control (HLFC) technology concepts. The CVG provides a wholly passive aerodynamic structure that removes/strips a fraction of all the lowest low-momentum layers of an incoming BL flow and thus allows the higher momentum upper BL fraction to then continue and re-attach or re-laminarize on the downstream surface with at thinner BL and thus reduced TKE and drag losses. The CVG then conducts this removed fluid-flow mass stripped along the step edge via a coherent flowing step-vortex and ejects this at the v-tips as intense vortex with a downward vector and in freestream direction (against a counter-rotating matching vortex), directly onto the output surface and submerged at the lowest possible part of BL for the additional benefit of flow separation, stall AoA extension control and particularly when configured for following shock and/or SBLI loss mitigation.

This is clearly superior to and not anticipated by LFC and HLFC, because no suction mechanism or energy loss or clogging fine-screen surfaces and/or meshes are need to achieve the benefits of directly improving the BL momentum layers. On a linear-motion fluid-flow foil (i.e. a non-rotating case) CVGs can be employed in cascade in series applications to improve flows, but the key and novel enabling technology is the unexpected and unanticipated capability of the new art CVG structure.

Cambridge University Professor of Aerodynamics Holger Babinsky points out in the 2011 reference tome on prior-art “Shock Wave Boundary-Layer Interactions”, on page 132 that “ . . . All types of VG's incur significant parasite drag . . . ”. This is an accurate and authoritative comment on all known prior art VG's. This is true because all known prior art VG structures and embodiments exhibit momentum deficits or entropy generation in the downstream fluid-flows, which represent energy loss and hence drag-count increments. Additionally, all prior art VG's tend to induce an away-from-wall (surface) velocity component that induces vortex buoyancy and hence tends to quickly cause these vortex filaments to move away from the wall/foil surface and minimizes any possible beneficial effect on the lowest level of the BL or sub-BL. Babinsky in US #2012/0018021 teaches a modified pair of ramp uVG's to generate streamwise vorticity inside a BL with the aim of improving supersonic-inlet SBLI losses and removing requirements for inlet bleed and also improving operating angle-of-attack by delaying flow separation. Babinsky '021 is actually very similar to Wheeler in U.S. Pat. No. 5,058,837, where wishbone or v-form VG pairs are used to generate streaming vorticity, as exemplified as item 116 in Wheeler '837 FIG. 5.

Babinsky '021 teaches that his uVG ramp, split-ramp, vane and ramp-vane embodiments in e.g. paragraph 0106, that “ . . . rise of the primary vortex from the floor . . . ” as a device embodiment ‘feature’. This vortex rising or ‘buoyancy’ away from the wall [also shown in his FIG. 15a] is known to adversely affect the vortex persistence and efficacy in dealing with a following SBLI interaction. At no point does the vortex filament center go significantly below the ramp height and touch (or go closer to) the wall/surface, as contrasted with CVG's that launch counter-rotating vortex filaments with a downwards velocity that ensures the filaments are attached immediately to the surface and are very persistent and at the lowest possible point in the BL. As a vortex rises away from the surface it loses the ability and effectiveness to influence or mitigate the SBLI wave drag or entropy generation. In paragraph 0106 Babinsky '021 teaches “ . . . Despite the drag penalty of the uVG's . . . ”, which again confirms that uVGs of ramp and/or blade form combinations are known to induce a drag penalty, irrespective of any potential downstream benefits, and paragraph 0103 further confirms that parasitic and loss inducing horse-shoe vortices are present in the uVG embodiments. Babinsky '021 teaches in paragraph 0186 “ . . . Additional benefits include negligible drag as evidenced . . . ”, but this at odds with the Table 6 entry for e.g. RV1B that shows the displacement thickness ratio as still 1.02 which is actually not negligible, but may be the best that a ramp/blade form device embodiment can achieve. These known problems with uVG prior art employed in; sub-sonic, transonic and supersonic flows do not occur with CVG art configured in the same flow environments and apparatus and used for optimum shock loss mitigation and flow separation improvements, with no drag penalty.

Staniforth in a comprehensive 1958 British ARC technical report CP No. 487 titled “Some tests on cascades of compressor blades fitted with vortex generators”, teaches that VG's on a compressor foil cascade suction (convex) surface show drag which “ . . . increased the two-dimensional losses under all conditions.”, and in conclusion, that: “ . . . the scheme of increasing the drag critical mach number of a compressor cascade by means of vortex generators is, on the basis of available test evidence, a failure . . . ”

Staniforth also teaches that it is “ . . . advantageous to suppress shock-induced flow separation in compressor blading . . . ” Staniforth analyses and suggests that his FIG. 7 Schlieren flow-visualization photographs show (partially) suppressed shock-induced separation. On close review, FIG. 7(b) actually shows that the prior art VG effect in fact intensifies the SBLI shock and separation losses, and this partly explains the failure of his tests to yield any expected beneficial result. Further review of FIG. 7(b) clearly shows that because the VG's are not completely submerged below the BL sonic-line (in the forward suction face supersonic flow before the usual pressure-recovery normal shock and SBLI) that they also generate additional local normal shocks and losses themselves, which are not present in the clean baseline foil of FIG. 7(a). This simply adds more shock, TKE and drag loss and makes certain the experimental “failure” he notes. The FIG. 7(a) image also clearly shows that a typical thin transonic compressor (or fan) blade induces suction (convex) face fluid-flow acceleration of a M0.71 entry flow to supersonic conditions before pressure recovery, and hence significant normal shocks and SBLI and fluid-flow energy and drag losses when operating around “on design” conditions.

Note the Staniforth test cascade is not a rotating blade cascade (which do have further and additional adverse outcomes when using all prior-art VG's) but is a fixed array of foils, that corresponds similarly to a linear motion foil result like e.g. a Lear24 wing. With the Lear24 embodiment of CVG's, it is known that ‘critical Mach number’ Mcrit is raised, and flow visualization shows that BL thickening of laminar to turbulent flow is generally suppressed over the whole wing upper suction face, and that the shock Lambda-foot BL disruption and hence wave drag is mitigated. This new art CVG SBLI result is unexpectedly and wholly different to that of Staniforth VGs on transonic foils attempting to gain the same outcomes. A compressor blade performs the function of inducing velocity and momentum and then pressure rise in a fluid-flow, and a bypass-fan blade is a special case in which a portion of the induced fluid-flow momentum is ejected via a cold-thrust bypass duct.

It is well known, based on high speed flight testing from e.g. the 1940's onwards, that foil surface SBLI upset of the BL when approaching/exceeding Mcrit can induce large chordwise flow oscillations and unsteady aerodynamic forces and shock Lambda-foot movements that couple into the surrounding foil surfaces and structures. For these reasons prior art VG's and other flow control devices are often employed to mitigate e.g. “aileron buzz” and other vibrational excitations and fatigue stresses on a high speed wing and other aeroelastic flow control surfaces downstream and up to the TE's. Clearly there is a large body of prior art aerodynamic technology stretching back many decades that has attempted to create a practical new art that can effectively mitigate shock losses, and many types of vortex generators have been attempted but with no significant performance improvement outcomes.

Mills (and skilled aerodynamicist Preston Henne) in U.S. Pat. No. 7,878,759 teach a “laminar-to-turbulent boundary layer transition control feature” for forcing an early BL transition point on a turbofan bypass-fan blade by intentional premature tripping of the BL from Laminar to Turbulent to reduce unsteady aerodynamic loads, and hence mechanical stresses. They do not teach any downstream thinned momentum-layer or reduced TKE and cannot claim any energy efficiency or fuel consumption improvement over any unmodified or baseline fan blade or disc; because all the prior art BL tripping elements or devices they teach; VG, Turbulator, raised bump transition (adhesive and roughness) strip, and inset-trench transition strip etc., all thicken some additional fraction of the possible laminar BL extent into turbulent flow with higher TKE, and so necessarily increase the viscous energy losses or entropy generation, which leads to increased flow or pressure drag.

For any possibility of the claimed “ . . . maintaining specific fuel consumption . . . ”, for their taught new-art, their premature BL transition art would be required to e.g. eliminate some other blade flow separation-loss bubble (e.g. stall) to reduce any net blade energy loss, that would then counteract the known increased drag losses incurred by their aerodynamically loss-inducing premature BL transition.

There are no prior art methods that reduce TKE or viscous drag by increasing BL turbulence and thickening, but the opposite outcome is well known. Conventional VG's and turbulator type devices and art are also known to increase drag on rotating blades (and in non-rotating cases) as clearly taught by prior art of; Martin and McVeigh, Staniforth, Shivers and Godsk '259 etc. Mills '759 fails to teach an outcome or operative physical mechanism that would lead to a better viscous drag outcome than the consistently adverse; Martin and McVeigh, Staniforth, Shivers and Godsk '259 drag results for VG's on compressor/fan and/or turbine blades over the last ˜55 years, which casts doubt on utility. Ludwig Prandtl is credited as saying ‘ . . . that almost any modification to the BL can be made by devices that will improve flow separations . . . ’, but this does not mean that drag due to turbulence, TKE generation and BL thickening may be reduced with this prior art.

Mills '759 fails to identify that a common or even predominant cause of failures in fans, and mostly in compressor blades (other than foreign object damage or FOD) is the mechanical overstressing and/or fatigue or damage of the thinnest outer tip sections of the blade foils; that on the rotors travel at greatest velocity, and are the most compliant, have least the mechanical support and are subject to tip to annulus endwall flow turbulence. The torsional vibratory loads and resonances around the blade feathering-axis produce strains that often critically focus at the weakest part of the blade structures; the tips and tip corners. The Campbell and Smith diagrams of the resonant and complex rotating component stability of e.g. a turbofan engine; show that aerodynamic interactions of the blades are a big contributor in limiting design operating ranges and critical shaft speeds. Mills '759 only teaches measuring strain (and inferring stress) in “ . . . the vicinity of where the blade joins the disc . . . ”. This is a highly stressed interface and requires inspections etc., but off-design events such as; shaft, disc and blade resonances and compressor surge or stalling impose some of the most severe loadings and overstresses at the greatest areas and radii from the disc or hub, i.e. the blade tips. Mills '759 also requires that his “laminar-to-turbulent boundary layer transition control feature” must be situated before any possible unstable Laminar transition point, whereas by contrast CVG's can operate behind/downstream of this often unpredictable and variable transition-point (e.g. due to blade surface changes over life), in now turbulent or thickened BL flow, and still have beneficial effects if sufficient flow energy/velocity exists at this lowest part of the BL.

CVG's operate in strikingly different manner to all the BL modification prior-art taught in Mills '759. CVG's are known stabilize and thin the downstream BL and momentum layer thickness and the unique streamwise persistent and intense sub-BL counter-rotating tip vortices act to stabilize and lower both downstream conventional BL separations and also SBLI separations, making these new art embodiments an unexpected outcome completely unlike, and superior to Mills '759 prior art. These CVG counter-rotating tip vortices generate mutual forces that tend to keep them in close contact to both one another and the foil surface and mostly submerged below the sub-BL.

Staniforth and Mills '759 and prior art teaching fails to identify that in a rotating foil case the centripetally induced above BL crossflows have a significant and adverse impact to any freestream components of any vortex action and also influences the development of the thickening post-transition BL. For this reason it is additionally and extremely adverse to employ any second row of VG's downstream of any earlier VG's on a foil subject to rotation, except immediately before the TE condition. This double sequential VG row suggestion by Staniforth is known, from flow visualization and drag increase measurements on rotating helicopter foils (i.e. as a cascade or actuator disc with low solidity), to be a bad or adverse embodiment choice for rotating foils. In the non-rotating foil case, cascades of two or more sequential CVG's may be usefully embodied.

Fiala in US 2011/0182746 teaches a sinusoidal blade suction-surface modification on a turbine blade that is located in the blade rear area after the cascade blade-passage overlap, defined by the next blade trailing edge influence, and typically after peak flow velocities and possible shocks. This prior art vortex generator Fiala teaches are a series of small transverse sinusoidal surface grooves that induce BL transition/turbulence and Gortler vortices at blade locations that are not controlled spanwise (i.e. radially). This means that surface damage or changes may adversely affect the location and geometric stability of vortex generation. At high flow stress conditions suction face SBLI shock impingement from adjacent blade trailing edges are a source of turbine losses that Fiala '746 cannot mitigate. Upstream of the blade-passage overlap, incoming transient upstream blade wakes are known to reflect from an adjacent blade pressure face and then impinge on a suction surface and split into forward jets and reverse facing jets. This adds extra turbulence to the earlier blade BL laminar flow that is steadily affected by growing turbulence, like Klebanoff streaks and premature bypass transition. So forward located CVG's that can directly mitigate blade SBLI losses and also provide high energy BL are functionally superior to turbulator or other schemes designed to increase BL turbulence in an attempt to reduce flow separations at low Reynolds numbers (Re).

Compressor blades and others, like Fan blades, also suffer from mutual SBLI shock impingement between elements in a cascade, but the shocks occur at the forward section or leading edge overlaps and hence affect a larger portion of the following blade surfaces and are also subject to incoming blade wake transients and separations since the majority of the suction face is a decelerating flow regime. CVG's inherently located at the leading edge are beneficial in loss mitigation of both shocks and BL turbulence and separation losses.

Kuethe in U.S. Pat. No. 3,578,264 teaches a series of bumps and troughs etc., to modify the BL on wings and blades, rotors etc., but fails to teach or claim his method produces intense sub-BL vortex pair filaments useful for SBLI loss mitigation, or actually reduces viscous losses at low AoA, or that his devices should generally be placed in the forward section of a foil to benefit from highest fluid-flow velocities. Routier in US# 2011/0200442 teaches a subsequent art modification to a turbine blade TE that is very similar to Vijgen'665, but also suffers from the same issues and also cannot mitigate the upstream SBLI impingement losses from other turbine blades of a cascade and blade passage arrangement.

Wood in U.S. Pat. No. 8,302,912 teaches shock bumps (like Schenk U.S. Pat. No. 4,354,648 structures) on transonic wings to mitigate SBLI losses and buffet and quotes Babinsky's uVG art. At best these are simply a refined well-known uVG type ramp device with a downstream fairing to try and establish better local generation control of streaming vorticity. Wood '912 does not teach the benefit of and does not have the capability of generating (at effectively zero-drag), streaming and closely bound counter-rotating vortex filaments at the surface at or below the sub-BL that have very high persistence and effectiveness in mitigating SBLI as new art CVG's can. Wood '912 suggests his bumps are placed at greater than 50% of chord, immersed at or behind the wing normal shocks and SBLI. At this point they are not at the highest velocity LE fluid-flows to generate most intense streaming vortex filaments and not optimal over a whole range of moving shock locations, and so cannot consistently mitigate SBLI losses. These Wood '912 bump/ramp structures protruding into and above the BL are structures that are known to induce drag, and his art simply is an incremental improved uVG, albeit in a sub-optimal location.

A rotating foil surface-crossflow (i.e. tending spanwise) condition will in general process any streaming vortex or shed filament fragment not intimately bound to the foil surface mostly below the BL and possibly sonic level (e.g. a sub-BL streaming vortex), and cause to it become angled to a degree to the foil chord and hence add a time varying lift and/or drag component as it rolls down the foil surface to the TE Kutta-Zhukovsky exit condition. This directly impacts and time-varies the foil Cm and hence induces a large and chaotic vibratory stress or torque around the foil feathering-axis. This outcome is also clearly seen when EPS materials such as e.g. Hontek coatings are placed on foil leading edges such as the Sikorsky UH-60 rotor blades. These increases in vibratory foil loadings can be sufficiently high so as to adversely affect the hub, blade and pitch control-link fatigue lives. By contrast, employing novel CVG type EPS systems in the same general helicopter main rotor locations leads to up to a ˜−30% reduction in RMS NP blade vibrations, and also up to a greater than e.g. ˜−9.28% measured dQ or power requirements for the same induced flow velocities or lift.

The deep dynamic-stall condition shows an almost identical action, where a detaching spanwise strong LE vortex (induced by the foil pitching rate condition) rolls down the suction face and induces large Cm variations, which then can lead to catastrophic diverging and undamped blade flutter and fatigue damage, depending on the blade's torsional response. This intractable problem leads to the requirement of limiting blade dynamic loading and operating envelopes to avoid this prior-art condition of development of intense spanwise LE vortices. CVG type structures and variations can be used to mitigate these dynamic loading problems.

Elastomeric lift enhancement: Gurney tabs have typically been configured at a foil or flow control surface as a (relative) pressure-face device at the trailing edge (TE) Kutta-Zhukovsky exit condition to improve aerodynamics. This prior art is to permanently attach metal L-bracket type Gurney tabs with rigid adhesives like epoxies, or rivet or weld them on to a foil TE. Additional work is being attempted on rotorcraft blades for cyclically deployable Gurney tabs or “MITES”, but all this prior art is either complex, or non-optimal and is problematic to employ beneficially on a wing TE because of mechanical compatibility, material fatigue, mass balance and aerodynamic-body aeroelastic flutter problems.

The ability to employ low-density and inherently mechanically weak elastomeric foams and specialized adhesive methods for creating freestream-transverse Gurney tabs in e.g. Mach 0.82 airflow is both; counter-intuitive and concept that both Aerodynamic and Mechanical engineers of ordinary skill in the arts of airfoil design reject as implausible, or even absurd. It is a completely unexpected outcome that such apparently “flimsy materials” can be usefully employed across transonic airflows to yield drag, efficiency and other improvements.

Application of these types of structures requires a lot more new-art and design consideration and engineering than simply; “ . . . attaching a low strength door or window weather-stripping material astride a nearly supersonic airflow . . . ”.

Employing low density weak elastomeric materials transverse to the freestream flow as modified Gurney or elastomeric Lift Enhancing Tabs (eLET's) is actually possible because unexpectedly these novel devices can be reliably configured to force-balance the majority of the aerodynamic force loads seen in the e.g. freestream direction, as disclosed herein. Additionally these eLET devices have been fabricated such that they are aerodynamically functional and can remain attached in transonic airflows and inertial accelerations of up to ˜61,000 gravities or more, on a bypass-fan Fan blade of an operating Turbofan engine.

There are many novel design considerations required for a successful novel eLET application such as, but not limited to the requirement for; operational reliability, serviceability and maintainability, fault tolerance from direct mechanical damage from e.g. ground handling, resistance to damage and detachment from high-speed rain and ice particle impacts and contamination from; fuel hydrocarbon and/or hydraulic, anti-ice fluids etc. Of particular concern is that on an e.g. transport aircraft, any aerodynamic device that can excessively affect the airframe trim will be on the aircraft dispatch minimum equipment list or MEL. In this case a flexible or elastomeric device may be mechanically damaged and need to be repaired, so the ability to be adhered with easily-removed adhesive means conveys a profound advantage in mechanical repair downtime and thus airframe availability.

Lin at NASA, in the 2002 paper “Review of research on low-profile “micro Vortex Generators” (uVG) to control boundary-layer separation” comprehensively describes many types of ramp/wedge and/or blade/vane Sub-Boundary Layer Vortex Generators, SBVG or uVG geometries and how they may be effective in BL and SBLI control. Babinsky in the 2008 USAF/AFRL report “Understanding micro-ramp control for shock boundary layer interactions” provides a good background on using SBVG/uVG's in scramjets. Babinsky '021 teaches the use of a variation of ramp-based uVG's for controlling boundary layer flow and interactions, and is similar in many respects to Dahm in US #2010/0288379 who also teaches a variation of ramp style uVG's for high speed flow control.

All this prior art uVG work has a fundamental problem in that it is primarily focused on ramp form VG and smaller scale ramp uVG's, which while they are compact and rugged, have the known intractable problem of creating entry shocks, entry horse-shoe vortices and hence are a loss or drag generating method of BL flow control. Stephens U.S. Pat. No. 2,800,291 “excrescences” are a well-known ramp style VG prior art that anticipates the majority of ramp style VG forms, at whatever scale. Stephens'291 suffers from the same drag-increasing outcomes as subsequent art, particularly at high velocity LE locations. Here the ramp-VG's induce large momentum deficits, TKE generation, added shock losses and complex and lossy horseshoe entry vortices, whilst being unable to process effectively the whole BL extent they are deployed across. Tested uVG geometries produce vortex filament action that is not extremely persistent nor directly attached against the wall or surface. As Babinsky 2008 points out, the lower-height and less energetic and drag-adding uVG devices need to be closely placed to a shock-foot to be even partially effective in SBLI control, and these uVG primary vortices tend to mutually induce up-wash and floatation immediately behind the ramp, as expected by Biot-Savart law considerations. The Babinsky 2008 conclusion also teaches that all the uVG ramp structures generate downstream low-momentum or energy deficit volumes due to device drag that complicate the interactions and mitigation of e.g. oblique shocks causing BL thickening.

For a desirable wide Mach-range scramjet embodiment it becomes a stringent or impossible uVG design requirement to force all shocks to maintain a fixed position to control SBLI. In addition to perturbing the entry fluid-flow streamlines away from the wall as a requirement to operate, these uVG structures cause significant secondary shocks in high speed fluid-flows (Babinsky 2008, FIG. 5a) and can accumulate ramp pressure-face heat loads and fluxes that must be mitigated. Additional flow problems in the scramjet are; struts, fins and rectilinear wall or corner intersections that induce complex 3D flow and shock disturbances.

Moorhouse in U.S. Pat. No. 6,880,342 teaches the use of a temperature controlled fuel-flow injection on a scramjet fore-body compression ramp to control the bounded aero-thermal ramp fluid-flow conditions to modulate the bow-shock angle to attain the “shock on lip” goal for varying body/vehicle or inlet Mach numbers. The Moorhouse '342 fuel temperature art does not address the barrel-shock drag and flow stability issues caused by injecting a fuel-flow through the BL and into a varying hypersonic flow-field, and does not address the additional secondary injector-induced oblique energy-losing shocks impinging onto the primary bow shock. Moorhouse '342 does not teach an improved mixing of liquid or gaseous fuels. The strategy of pre-injection of higher molecular-weight fuels like JP-7 or JP-10 to allow extra engine transit-time and temperatures for energetic decomposition of the long carbon-chain species into numerous faster reacting smaller molecule species is widely known prior-art to Moorhouse '342. Additionally Moorhouse '342 does not address the entry BL growth, stability or add any method of inlet BL ingestion control beyond the well-known energy-consuming method of active BL suction. Moorhouse '342 requires the complexity of heat exchanging and control of higher density liquid fuels that cannot respond inertially as rapidly as e.g. a cooling gas fluid flow. Low molecular weight and energetic fuel fluids such as liquid or slush-hydrogen cannot employ this Moorhouse '342 pre-injection control methodology because activation and reaction times in the face of high inlet entry oxidizer temperatures are not safe and would allow exothermic reaction/combustion to begin prior to the inlet entry or within the isolator section, leading to adverse flow disruption, thermal choking or unstarting and possible explosions. Volatile and fast reacting/oxidizing fuels are thus limited to reacting in just the combustion chamber volume. In any case, a practical wide speed-range scramj et typically requires a mixture and blending of fuel flows and combustion locations as it traverses an ascent velocity profile to e.g. orbit or other location.

### BRIEF SUMMARY OF INVENTION

Improved operating energy efficiency and performance envelope by shock and related separation loss mitigation is the primary goal of this invention, and a number of embodiments and derivatives, taught herein.

Modifying a Slat-less Lear24 (registration N196 TB) wing with a LE Slat emulation using a spanwise tape layer provides the expected adverse result (as noted earlier for the slower-flying Piaggio P180); that at a preset baseline weight and cruise power setting, airspeed is reduced by ˜20 knots at ˜M0.82 cruise. This again proves on a real flying aircraft that the wing L/D ratio is compromised due to a LE Slat type of spanwise AFS flow discontinuity and resulting flow disturbance. After intensive inventive exploration of many embodiment types it was discovered that novel configurations of Conformal Vortex Generators (CVG's) presented herein could be setup to provide the unexpected outcome of significantly mitigating this Slat flow impairment and energy inefficiency.

For the Lear24 wing, the performance improvement was novel, unexpected, very pronounced and of significant operational value and utility. The baseline or reference wing condition was tufted for flow visualization and showed mostly turbulent or thickened BL flow across the whole wing span, from ˜4% chord, rearwards to the trailing edge (TE); from stall speed (Vs) to maximum speed (Vne). This test wing was a rare early “Raisbeck-improved” version without added prior art high-drag vortex generators, fences and bumps etc., subsequently employed by Gates LearJet Inc. (refer to Schenk '648) to improve wing controllability on subsequent aircraft and models. This is particularly true at low speed and full aerodynamic wing stall, where the e.g. Lear24 and other models have an infamous tendency for a random and violent wing-roll stall breakaway with impaired controllability.

With the new art applied, the Lear24 wing tufting flow visualization unexpectedly showed no significant thickened or turbulent BL flow on the wing behind the Slat emulation and new CVG embodiments, from Vs to Vne. Additionally the tufting was configured in a novel manner to witness and record the normal-shock SBLI Lambda-foot location at the peak test-speed and intensity of ˜M0.82. The baseline case shock Lambda-foot location was at about 35% cord, but most unexpectedly was so attenuated in the new art CVG case so as to not register as any strong effect. Testing also confirmed that critical Mach number (Mcrit) was raised for the wing. Mcrit is not a “hard” limit, but is set as a reference by the airframe manufacturers as a predefined drag-count increase (typically ˜+10%), where the rapid power-law increase in e.g. Mach shock intensity and hence wave-drag makes faster cruise energy-prohibitive.

Testing at different speeds infer that the unexpected CVG performance improvements result from a combination of; BL re-laminarization that allows downstream sheared flow reattachment and BL thinning and NLF type drag improvement after the Slat discontinuity and CVG location, and additionally effective sub BL vortex impingement on the SBLI Lambda-foot. This intense sub-BL vortex impingement reduces the BL thickening at the SBLI location at the most effective sub-BL surface location (mostly below the sonic line), and hence lowers wave-drag and viscous drag significantly. The net result of the new art wing CVG mitigating a Slat performance problem is to reduce the total effective Lear24 airframe drag at ˜M0.82 by about −8% from new art CVG application just to the wings, and was reflected in combinations of reduced fuel flow and/or increased cruise speed, depending on engine power settings. This simply makes N196 TB indisputably the fastest Lear24 in the world. Note that without Slat emulation on this Lear24 wing LE, CVG application is even more effective in improving drag and energy losses, since the Slat AFS discontinuity is not present on the baseline wing.

At full aerodynamic wing stall (past stick-shaker warning) this CVG equipped Lear24 showed a significantly lower Vs with a ˜−10% reduction; and no wing roll or drop-off tendency, in either direction, which is a prior-art notorious problem with this aircraft wing. Note that these type of outcomes are wholly unexpected by application of prior-art methods and are not CFD simulations or Wind-tunnel tests, but real flying aircraft with unambiguous and novel outcomes over all known prior art. CFD technology has not yet reached a maturity to fully and accurately model all possible sub-BL turbulence and viscous losses at these viscous sub-deck layers, close to the wall and over a number of interrelated and sequential flow regimes. Likewise wind tunnel testing is so circumscribed in sizing, costs and flow restrictions that the wall influences and Re effects of scaled models makes it implausible for researchers to independently derive these results with just these limiting tools. Placing the necessary LE trip wire to make the macro-Re geometry of a necessarily scaled wing in a wind-tunnel resemble the real world test results, means that any early BL and sub-BL is completely disrupted by early BL transition tripping to turbulence by this trip wire, or calibrated surface roughness. This effectively blinds innumerable and capable researchers from the ability to accurately model and predict early and subtle BL development on a real wing with Slats, leaving the only effective option to fly and develop any real-aircraft novel configurations.

Combining a specially configured new-art wing TE eLET with the new art CVG embodiment on this Lear24 wing yields a novel and interacting aerodynamic configuration that further provides an unexpected operational performance improvement. The baseline reference or unmodified Lear24's fuel consumption (or burn) is −710 lb or 322 kg of JetA fuel to climb at 250 knot airspeed from 1,200 feet above sea level to 30,000 feet. For this novel combination of both the eLET and CVG added embodiments, the same flight path requires ˜500 lb, or 227 kg of fuel. This is at the same condition of aircraft initial Maximum All up Weight (MAUW), airspeeds, and air temperatures and density altitudes. This approximately 30% reduction of fuel burn or improved energy efficiency for a transonic swept-wing aircraft employing these new art embodiments from takeoff to Top of Climb (TOC) is a result unprecedented with any known prior art. Flight in icing conditions shows that CVG fabrication material can be selected with sufficiently low surface-energy and other physical characteristics like surface smoothness, that when not heated by anti-ice hot bleed air, does not allow any LE accumulation of ice on CVG surfaces, whereas an immediately adjacent normal Lear24 polished high surface energy stainless steel LE section accumulates ice if similarly left unheated. The eLET structural compliance means that it can bend and deflect so as to shed any local ice accumulations at the TE without needing anti-ice capability like heating, whether on a wing or a rotating blade.

The Embraer 170 as noted before with adverse Slat flow impacts, and other aircraft such as Boeing 737's etc., that employ Winglets often have an increased drag problem induced by a post-design/Certification modification, where an EPS tape or metal EPS strip is added to control LE damage and erosion that occurs in real flight operations. This typical AFS step discontinuity measured on e.g. a Boeing 737-300 winglet EPS transition is ˜0.26 mm or worse, which is in the range known to induce premature LE BL transition to Turbulence and increased losses. LE damage is just as critical on any winglet (as for a wing, or any other flow modifying surface) in reducing the downstream NLF low-drag performance, and more so if the jet aircraft cruises faster than e.g. the P180 turboprop at ˜M0.65. On these aircraft CVG's may be added to the LE that mitigate these winglet EPS flow degradation problems caused by the added EPS spanwise rear edge AFS, and also reduce shock SBLI losses. Simply adding a LE EPS that is inset into a rotor or fan blade results in another problem; in that the thin interface transition to the following surface material is very hard to fabricate with no surface flow discontinuity. Additionally it creates a very narrow edge bonding point of e.g. ˜0.25 mm that will eventually fail due to temperature changes and other mechanical stresses and lead to growth of an uncontrolled spanwise discontinuity/trench that allows post-EPS erosion and increasing drag losses to occur. This mechanical degradation effect is seen after service use on both the Sikorsky S-61 composite main rotor blades with Nickel LE EPS strips, and the composite GE90 turbofan bypass-fan blades with Titanium LE EPS strips.

Clearly all these new art improvements may be employed singly or in any effective combination on any large or small airframe, to improve; stall speed, drag and/or energy efficiency, cruise speed, resistance to NLF drag degradation from accumulating LE damage or contamination, noise generation, engine life (due to lower power exceedances from lower power requirements) and erosion protection.

On some newer model Boeing 737's for example, a number of prior-art blade type VG's ˜20 mm tall and angled to freestream are employed inboard at around ˜20% chord for flight trim, and also outboard at ˜50% chord to mitigate “aileron buzz” or transonic shock oscillations and vibration due to manufacturer specified cruise speed above e.g. Mcrit. This is possibly for competitive reasons, since a higher speed aircraft is generally more valuable to an airline. A blade VG's primary vortex filament sheds from the top rear and shows a momentum deficit, indicating an adverse drag increment when active, and these vortices are generated and act well above the local sub-BL and are known to convect up and away from the wing surface after they exit the VG blade rear. This means that these vortices interact much higher in the normal shock structure above the Lambda-foot, (not close to the sub-BL) and so actually have some minimal effect in reducing transonic wing wave-drag while helping a little to mitigate normal shock oscillation and shock stall.

By contrast employing correctly configured CVG's on a Boeing 737 or other transonic straight or swept wing allows direct mitigation of the SBLI Lambda-foot shocks to significantly reduce wave-drag energy losses or directly fuel consumption, and in addition the CVG's can also be configured to suppress wave-drag losses for any normal (or even oblique) shock on a wing lower or pressure face and any other aerodynamic surface or surface combination, at higher cruise speeds around or above Mcrit.

Testing on a Boeing 737-505 aircraft (registration N737EX) of one embodiment of; 0.35 mm tall ˜38 degree CVG arrays (swept asymmetrically at ˜28 degrees to match the wing sweep) and with ˜30 mm long maximum step length and ˜2 mm tip and valley radii, outboard from the engine pylons to wing tips on the wing top at about 20% chord location, shows a decrease of ˜−6% total drag and fuel flow at e.g. Mach 0.78. Total airframe drag is reduced from M0.64 through to M0.80 and the maximum cruise range and speed is extended similarly by this drag or energy efficiency improvement. Using this embodiment it possible to increase the typical cruise speed of the 737-505 from the M0.74 baseline speed to M0.78 with the same, or lower fuel burn rate. This embodiment outcome is typical just for one version of CVG's on the 737-505 wing suction face, and additional similar and cumulative efficiency gains are possible from applying configured CVG's to the; horizontal stabilizer, rudder/empennage, engine pylons, engine nacelles, and fuselage body and areas with disturbed flow and shock discontinuities like the cockpit windows and brow transitions.

Images of the 737-505 wing in flight at M0.80 show lambda shock-foot shadowgraphs that clearly indicate sections of this shock foot, located downstream of about 50% chord and inboard of the aileron conventional VG array, that are distinctly modified in intensity and location by upstream CVG arrays. The areas with improved CVG BL incoming flows show the shock foot shifted in the downstream direction as expected. Comparing the shadowgraph effects of the discrete VG's further outboard, it is clear that these conventional VG's are not as effective and are less uniform than CVG's in influencing the lambda shock-foot. This also shows CVG's are very effective in suppressing dynamic shock-stall or “aileron buzz” effects closer to maximum flight speed limits. Surface tufting also confirms the same outcome in wing surface flow improvements as taught for the smaller sized Lear 24, in that CVG's act to affect and lower the majority of downstream wing-area surface turbulence, so clearly improve energy and fluid-flow losses over and above the known shock-loss mitigation occurring at higher shock regime Mach numbers. This confirms the CFD of the 737's e.g. BA-449 wing foil, that shows at about +2.5 degree cruise AoA that the rear section of the suction or top face of the wing is subject to increasing surface flow turbulence in a non-Laminar and Turbulent flow regime. As expected, the CVG's also act to reduce wing stall speed, as seen on the Lear24, which at 13,800 lb max weight is only about 10% of the 737-505 max weight of ˜135,000 lb. Drag losses in the Mach shock regime on e.g. a 737-505 wing begins at ˜M0.615 when the Boeing control laws begin to introduce Mach Trim as the shock begins to change the wing pressure loading and thus pitch/elevator trim. This 737 wing design is from the 1960's, before the value of supercritical NLF and large LE radii flow improvements for transonic foils were known. The large shock/wave drag loss improvements when CVG's are added in tandem with existing conventional VG's confirms that relative CVG effectiveness is markedly superior, and shock imaging shows that the CVGs effects shift the shock foot line aft in a smooth continuous line because of the high density of low-drag vortex filaments and improved BL turbulence, unlike discrete VG's that have effects limited to separated points.

The superior flight performance and drag reduction outcomes mean that the application of CVG's also then allows for the STC/Engineering Order removal of the 737 conventional wing VG's, and since these numerous VG's each contribute a documented drag loss, this allows a further improvement of airframe performance.

Flow visualization of the body-of-revolution Lear24 tip-tank devices (or other e.g. fuselage, slender fore-body, drop tank, or other external stores with approximate e.g. low-drag Sears-Haack body profiles) shows flow separations at; zero or non-zero AoA are improved by application of a CVG device. This can be embodied in many ways, including a helical (interrupted) winding configuration in a single or sequential multiple CVG series with rear-pointing tips. It is clear that the result of such CVG application reduces pressure drag by improving viscous and wave drag losses; and improves interference drag from shock waves induced by tank/wing intersections, and/or normal and oblique shock impingements and SBLI losses between different interacting surfaces. In a yawed-axis flow case, optimal CVG embodiments on these bodies ensure that large forces from any flow separation and asymmetric vortex development will not induce adverse loads on this; external device, attachment means and/or host airframe, thereby improving handling qualities and operating envelope.

Flow-control devices like; wing and control foils and surfaces, any rotor/stator turbine and compressor and fan blade arrays, centrifugal compressors and turbines, ducting, propellers and hydrodynamic devices like water jets, hydrofoils and structures in liquid flows may use this new CVG art to improve performance and lower drag and/or energy losses.

For compressor/fan blade cascades there is a significant gain in operating performance and envelope ranges when embodying CVGs, because supersonic, transonic and even low speed blades can all suffer from significant flow separation or stalling, if the incoming positive or negative incident flow angles exceed the blade aerodynamic capability and thus thicken the BL, and approach stall conditions. This is because rotor and stator blade and cascade aperture diffusion required for inducing velocity increases and then compression tends to induce a flow-wise adverse pressure gradient that can lead to suction and/or pressure face BL separation, and hence large drag losses at off-design conditions, or during fluid-flow transients or surges. This diffusion influenced separation limits the low-loss and efficient design range for any compressor cascade stages and turning angle capability, which forces the requirement to limit stage pressure gains, and so include additional (heavy) compressor stages to achieve the design targeted pressure ratios and efficiencies.

Additionally at higher inlet Mach numbers, blade; normal shocks, passage shocks, TE and LE bow-shocks develop between and around the adjacent blades in a cascade that then interact via SBLI to increase shock-induced BL separations and losses. To compound these performance limiting problems, upstream blade wakes or momentum deficits propagating from earlier stage losses additionally impact downstream blades and ‘reflect onto’ suction and/or pressure faces as adverse BL flow disruptions, and even negative-jet action that reverses local BL flow direction. For counter-rotating compressor and turbine cascade designs the upstream wake interactions are even more severe than for conventional rotor/and fixed stator cascade combinations.

The losses and safe operating ranges of; flow velocities, mass flows, temperature and density altitudes of any type of existing cascade designs can be significantly improved by changing prior art blades to plug-compatible new art CVG enhanced blade designs that are configured to match; interface dimensions, mass flow rates and velocity profiles, but with much improved SBLI loss, separation losses and dynamic operating range performance. Typical prior art compressor blades may employ a Diffusion Factor (DF) limited to ˜0.45 to ensure a low-loss blade loading with sufficient operating-line stall and surge margins. New CVG-enhanced blade designs can approach or even exceed the prior art DF practical limit of ˜0.6 and still have sufficient and safe off-design or dynamic operating margins. CVG blades can have; significantly larger stall-free solid turning angles that allow for fewer stages, and/or higher resistance to stall and surge propagation. This allows a more robust and reliable cascade design, with less dependence on variable Inlet Guide Vanes to modulate varying mass-flows and velocities to keep blade incidence angles in a safe unstalled range. Compressors absorb ˜60% of the fuel energy/enthalpy in a typical engine (and 100% in a pure industrial gas compressor), so improvements here have profound impacts on overall efficiency, fuel flow and net exhaust gas emissions.

The next generation of open-rotor versions of the turbofan engine can be designed where the numerous unshrouded fan rotor blades may be efficiently configured using CVG's (particularly closer to outer blade tip regions) such that a complex ‘scimitar’ or swept LE blade is not required to mitigate blade shocks and minimize outer tip flow losses at high transonic speeds. This allows a new straighter or less curved LE sweepback configuration that allows for a mechanically simpler and stronger blade. The hub pitch actuation mechanism is now simplified because there is much less change in the center of aerodynamic pressure positions and feathering-axis torques on low LE sweep/curve blades, and hence hub blade-torques, if blade pitch angles of this cascade/rotor are changed. Naturally this same logic follows for CVG's embodied on e.g. turboshaft engine driven propellers and similar propeller prior art. CVG embodiments applied to Beech 1900 turboprop Hartzell composite 4-blade propellers have 890 shown ˜−14% reduction in fuel consumption over ˜7 hrs of flying varied sectors, by lowering flow separation and shock SBLI losses over a wide range of these propeller operating conditions.

Testing of CVG-enhanced foils teaches that thickness-noise, separated flow disturbances and shock-excited acoustic wave generation is reduced by up to ˜−6 dBA peak changes, or more. Radiated and component-conducted acoustic noise are effectively proxies for unsteady aerodynamic loadings and the vibratory modes then coupled into components. CVG's reducing the Turbulent BL extent and intensity and removing SBLI, unlike Mills '759, are beneficial to then lower blade and component strains and hence improve any affected component's fatigue life. This is a provably different outcome to the Mills '759 prior art, because lowering the BL turbulence and hence surface pressure fluctuations (particularly about the aerodynamic center of pressure or feathering axis) has a direct response in lowering; the foil surface forces and hence vibration coupling and strains, and then fatigue life.

Relaxed or reduced operational resonance problems identified on e.g. Campbell diagrams are the outcomes of lowered noise and vibratory stimulation of working components.

Huang et. al. in the 2013 ASME paper “From rotating stall to surge: a shock tube mechanism” teaches an innovative explanation of the unknown initiating mechanism of potentially destructive transient compressor surge in turbofan engines, such as the CFM-56 (and other turbomachines). Blades employing CVG's along the LE inboard and outer regions have a significantly extended stall AoA capability (in excess of ˜50% improvement) without any “prohibitive” drag increase, so are configurable to be completely resistant to this type of transient rotating-stall and then the cascading flow breakdown of dangerous compressor-surge or stall. Turbine blade cascades operate in slightly different manner to compressors, with higher resistance to blade stalling since the flows are not decelerating, but the flow and shock loss mitigation benefits of CVG's are analogous and can be employed to improve operation and cascade designs by generally mitigating flow separations and shock losses around the blade passages, as already described herein.

Note that it is not typically possible to eradicate normal or even oblique shocks directly, since these are caused by fluid-flow interactions caused by flow controlling surfaces that decelerate a fluid-flow (even to below the local sonic speed) and hence cause an entropy or energy loss. What is possible is that this new art embodiment can be configured by; design, experimental verification and adjustment to mitigate the BL losses in an adverse SBLI, or equivalently a SWBLI situation. New blade and cascade designs can thus employ CVG's to create invaluable; lighter, more efficient, lower maintenance, longer life and lower-cost engines and compressor devices with fewer stages and propellers, rotors etc., with greatly improved dynamic operating envelopes.

For very high speed flight like the proposed hypersonic civil transport like the Rockwell X-30 SSTO space-plane or small scale X-43, flow instability, heat control, the control of shocks and shock separations are key to a successful and operable and reliable design. Here CVG's may be used to ensure e.g. the typical e.g. Scramjet engine shock-compression system and isolator-ducting can be operated stably over a larger range of; velocities, transient and normal/oblique shock conditions; by embodying CVG's operating above and/or below the local sonic line and mitigating SBLI and ducting Corner Separations, which significantly reduces the risk of Scramjet inlet-unstart or damage. Additionally CVG's and low-drag ejection vents may be configured to introduce LE or surface-cooling or density modification gasses, or fuels into the high speed engine fluid-flow, with a low drag-loss surface-spreading or mixing structure. Additionally, a high speed shock modification scheme employing a modified CVG in an e.g. Edney type VI Shock Classification interaction can provide a very high-speed method to slightly modulate the bow-shock angle, to servo the inlet flow fields to maintain a “shock-on-lip” condition.

An unstable or positive feedback due to engine BL separations at any point of the flight profile can lead to increase in fluid-flow mass decelerated to being sub-sonic and this can lead to flow-choking and massive fluid-flow breakdown or engine “unstart”. Since a civil transport fluid-flow regime may be a mix of; hypersonic, supersonic and a small amount of sub-sonic flows, the reaction time of any possible control system or modification method has to be exceptionally fast and is typically beyond the scope of most mechanical systems such as ramp or duct lip position or wall angle control.

New fluid-flow control structures engineered and applied to overcome all these prior-art problems, and provide; an effective and drag-reducing passive control of BL flows, a geometrically stable and area-control of BL separations, and that allows low-drag/shock injection of; cooling flows, fuel fluids, BL densification gases, reactant augmentation and control of “shock on lip” geometry and flow control actuators would be a valuable addition to the current art.

CVG's of any suitable material to establish correct functionality, will improve the; shock losses, flows, vibrations and noise when added to an existing rotating foil like a helicopter/compressor/turbine rotor or a propeller, etc. (or alternately a fixed stator/wing). If added to new blade/foil design and fabrication it is now possible to operate at higher speeds and further into compressibility effects by delaying catastrophic drag increases from shocks. This provides increased design latitude and operating envelope for both old designs and new designs.

Results as disclosed in this new art presented herein, require inventive; insight, perseverance and determination in operating on e.g. expensive real world airframes to reduce these potential benefits to practice and then provide useful; fuel saving, energy efficiency and greenhouse gas emission improving products. The nature of the performance shifts obtained by this new art are so much greater than any prior art improvements, that no known combination of these prior arts are suggested that would approach this disclosed new art performance. These significant performance improvement outcomes are an indication of the novelty of this new art and embodiments over prior art which has not shown these prior capabilities or reduction to practice. These embodiments may be retrofitted and used with a Supplemental Type Certificate (STC) authorization process for any existing target aircraft, device or apparatus, and also easily added into any new airframe or device design, fabrication and Airworthiness Certification requirements. Additional embodiments may be applied as sensible to further improve the performance of items they are configured upon.

### BRIEF DESCRIPTION OF THE SEVERAL VIEWS OF THE DRAWINGS: (5 SHEETS)

All drawings are not to scale, but are detailed with many optional embodiment features, for illustrative purposes.

FIG. 1 details a wing underside view representation employing a TE flap and LE Slat (extended) arrangement to improve low speed lift capability, along with CVG and eLET arrays to improve performance.

FIG. 2 details a cross section of the TE embodiment of an eLET tab and buffer alignment strip art that provides improvements in wing efficiency and operating range, particularly in combination with CVG's improving shock losses.

FIG. 3 details an embodiment of an elastomeric vortex generator (eVG) art that provides a wing high speed cruising mode Slat-retracted gap-seal capability and/or improved Slat-extended wing stall capability at low speeds, as well as cross sectional variations of eLET and eVG body shapes.

FIG. 4 details a wing topside representation employing a TE flap and LE Slat (extended) arrangement to improve low speed lift capability, along with CVG arrays to improve performance by reducing shock and flow losses.

FIG. 5 details a wing cross section representation with a LE Slat (retracted) arrangement that outlines the relative effects of prior art blade VG and new art CVGs in modifying wave drag by lambda shock-foot impingement.

FIG. 6 details an alternative CVG embodiment at a slat trailing edge.

FIG. 7 details a turbine blade cascade showing locations of typical shock and other losses.

FIG. 8 details a compressor blade cascade showing locations of typical passage shocks.

FIG. 9 details a foil LE with an embodiment that suppresses deep dynamic stall Cm.

FIG. 10 shows a cross-section of a high speed vehicle with scramj et propulsion that benefits from multiple applications of integrated CVG's to suppress shocks and flow problems.

### DETAILED DESCRIPTION AND BEST MODE FOR CARRYING OUT INVENTION EMBODIMENTS

FIG. 1 shows the arrangement of a common example of a wing 2 with both a downward deflecting TE flap 3 before the TE 15, and a LE Slat 4 in the un-retracted low-speed position at the wing LE 16. The relative incoming fluid-flow or upstream freestream 1 is shown by an arrow and this allows the AoA to be defined by the relative angular deflection of the wing chord line (or the flow control surface extents) from this freestream velocity vector. Slat slot 5 open in the low-speed extended configuration accelerates additional fluid-flow over the wing top or suction face 6. A wing pressure face 7 TE array of eLET body 8 are configured as the required coverage from near the wing tip 12 to wing root, and possible Yehudi root rear chord extension 9. Wing TE array of eLET body 8 are applied in sections to ensure fault-tolerance if any section becomes detached in flight. This is critically important because this TE array of eLET body 8 addition changes the local wing C_{L}, as well as C_{D}, which has the effect of creating a possible wing roll-moment input if reasonable wing lift-symmetry is not maintained. The eLET section gaps 11 may be configured as; closed to any fluid-flow or wide enough and angled so as to add selectable and controlled streamwise wake TE vorticity from these structures, that are situated wholly before the wing TE and the trailing Kutta-Zhukovsky exit condition at 29. The TE array of eLET body 8 is shown optionally attached onto the flap 3 and TE fixed and control surfaces. This is possible because this new-art configuration is a low-mass compliant and active aerodynamic structure with shear force spreading capability that puts minimal stress on the thin TE of these flutter-sensitive control surfaces.

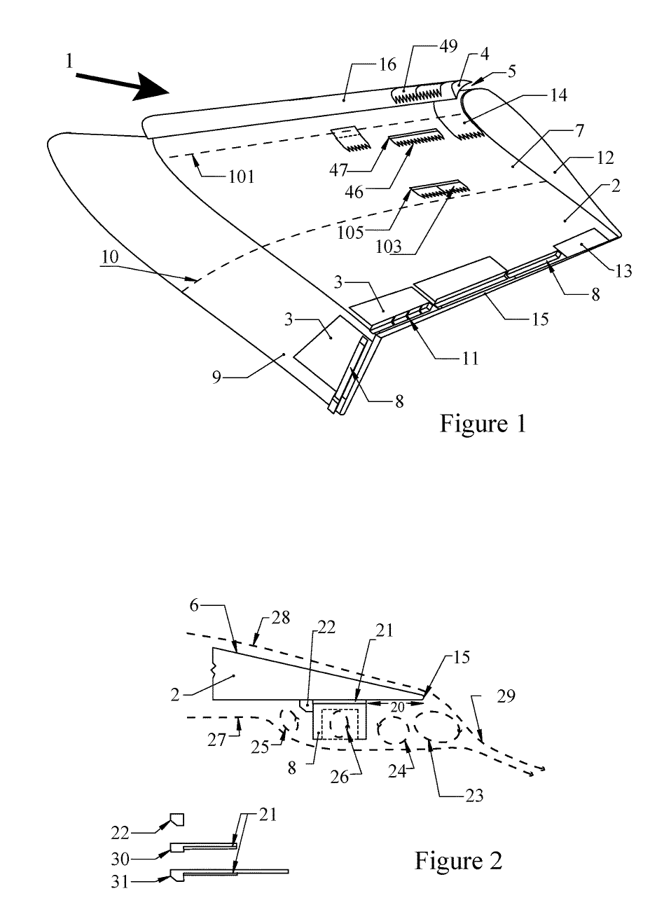

FIG. 2 shows the addition of an eLET body 8 with tab offset 20 from the TE 15 of the rear portion of a wing foil, which allows the generation of typically two or more compact spanwise vortices, e.g. rear tab vortex 23 and forward tab vortex 24. These two tab vortices act to add extra force on the fluid-flow exiting the TE 15 and acts to increase the downwash vector angle towards the pressure-face side and hence increase lift vector, in the opposite direction. This also communicates extra flow velocity upstream along the suction face streamline 28 into the sub-sonic part of the suction BL after any normal shock (where Mach number transitions to less than 1.0) and effectively makes the foil chord appear to be aerodynamically extended, and lowers drag. Ahead of the eLET body 8 may be configured an entry transverse entry-vortex 25 that conditions the entry pressure face streamline 27 for lowest energy configuration. Fluid flows are indicated with small arrows on the dashed fluid-flow lines. The eLET body 8 is typically adhered by eLET adhesive 21 to and/or behind a buffer alignment strip 22 that then is permanently affixed accurately to the pressure face 7 at the design location. The strength, flexibility and/or persistence/life of eLET adhesive 21 is chosen to be suitable to allow for easy eLET removability and maintainability, whilst being sufficiently strong to attach eLET body 8 reliably over its designed operating life, and be resistant to any chemicals like; cleaners, anti-ice compounds, fuels, lubricants and hydraulic fluids etc., that may be present. Buffer alignment strip 22 is configured to provide a durable and permanently attached base to support eLET body 8 and has a forward profile that is configured in any functional way to fundamentally overlap and cover or shield the leading edge of eLET adhesive 21 from impact damage from service handling and impacting matter/debris such as; ice crystals, rain/liquids, dust, sand, volcanic ash and insects etc. These may impact at high velocity closely along the incoming BL and hence could disrupt the adhesion of a lower-strength but easily serviceable bonding system like item 21. Buffer alignment strip 22 may be omitted, and eLET body 8 bonded directly with a high-strength and/or permanent adhesive system, but that then is an inferior embodiment, because it is harder to maintain and service time-efficiently when an in-use condition requires repairs. A permanent adhesive type system will typically leave a surface residue or damage when mechanically or chemically removed, which makes the maintenance process more complex, time intensive and costly, since damage to the surface or protective paint cover then needs to be corrected.

Buffer alignment strip 22 may be fabricated in any material of suitable density and flexibility that is durable for incoming matter impacts, with surface energy configured for attachment; which could be a mechanical fastener or adhesive system against the pressure face 7. It can be formed by any known or future art manufacturing process, to dimensions that are suitable to shield the size of the; chosen eLET adhesive 21, and the eLET body 8 size being used on the particular foil, which is a typical height of ˜0.1% to 3% of foil chord, depending on desired aerodynamic effects. Tab offset 20 is typically in a range of zero to approximately 5 tab heights forward of the TE, but this is not a limiting condition, and can be adjusted as required to modify the tab-induced shift in either; drag, lift and/or L/D ratio. Setback from the TE of the eLET body 8 by Tab offset 20 as a fraction to several tab heights, allows for improved downwash magnitudes and higher effectiveness, depending on whether a lower-drag or higher-lift configuration optimization is desired. Tab width will vary depending on configuration and typically a tab height-to-width ratio of 0.1 to 5 is practical. Final testing on a flight surface determines the best embodiment final dimensions, based on the general configurations taught herein.

FIG. 2 also shows an alternate buffer alignment strip 31 version that may be adhered wholly underneath the extent of eLET body 8 and on pressure face 7, and extend back to the TE 15. This makes installation easy to perform and verify but slightly heavier and less flexible. It is possible to reduce the buffer alignment aft section so as terminate under the eLET body 8 at the rear, as a medium length buffer alignment strip 30 or even terminate at the eLET body 8 front-face as a shortest buffer alignment strip 22 (not adhering under the eLET body 8), as shown for approximate size comparison. Buffer alignment strip 30 is shown with a square LE entry which is to indicate that this entry geometry is not critical and that this buffer strip is present to protect the eLET adhesive 21 interface. Note that the diagrams are not strictly to scale; and for example the adhesive 21 thickness is exaggerated for illustrative purposes. In a functional embodiment of this new art, the most critical dimensions are the tab heights of eLET body 8 and Tab offset 20, as discussed, and variations of these embodiments and geometry are possible and considered as part of this new art.

eLET body 8 can be a solid block of suitable material as shown, or configured as one of numerous variants such as; a “U” form item 33, an “F” form item 32, “T” item 34, “L” item 35, “Pi” item 36 configuration etc., and formed in an Open-cell or preferably Closed-cell interior low-density foam or elastomeric material so as not to retain any liquids, contaminants or dust etc. Variations in the part geometry and e.g. edge radii based on these fundamental shapes are possible and considered within the scope of this new art. eLET body 8 and/or variations are typically fabricated and processed in one or more steps, with one or more materials to form essentially a smooth-skinned or effective attachment surface at the attachment area or point. A mix of foam densities and elastomeric/plastic materials can be combined and then configured for best performance. In the ““U” form item 33 configuration shown as a variation overlaid in FIG. 2 as a dashed line modification, a tab internal vortex 26 is induced that helps keep the thin eLET walls from collapsing from the greatest aerodynamic forces acting along the streamline direction. The viscous energy cost for any supporting vortex structure is balanced against the value of having a smaller volume or lower mass tab configuration.

Unexpectedly, the low mass and high flexibility and compressibility of an elastomeric material, in essentially a unique aero/hydrodynamic force balance, is very effective at holding its required shape and inducing desired beneficial vorticities, even up to transonic or local supersonic flow velocities. This compliant elastomeric material system also filters aero/hydrodynamic forces, pressures and acoustic noise and stresses from coupling to the underlying surfaces, and places the absolute minimum of added; weight, inertia, fatigue and stress onto the underlying surface.

Of particular note is that the elastomeric body material(s) and adhesive attachment system form a unique system that unexpectedly can attach dissimilar materials onto an aero/hydrodynamic flow-control surface (like a; wing foil, hydrofoil, support strut, rotor blade or propeller, etc.) in a highly stressed situation and provide retention in the face of large aero/hydrodynamic forces, and particularly very high inertial accelerations if rotating.

Retention of elastomeric materials as e.g. tabs, VG and CVG structures on jet engine fan blades at ˜61,000 gravities or more are unexpectedly much greater than the bonding capabilities suggested by e.g. common ASTM materials specifications and test methodologies of the baseline adhesives and materials. This unexpected outcome is due to the fact that an elastomeric material is capable of inherently flexing and distributing and thus equalizing all the aero/hydrodynamic, inertial or other forces evenly across the complete bonding interface area, such that any local surface interface slip-condition that could rupture attachment is not exceeded on both the; (a) substrate to adhesive interface and (b) the adhesive to elastomeric body interface. This force-balancing and load-strain sharing is due to the unique combined employment of; flexible adhesive systems coupled with a flexible elastomeric elements being attached. This is clearly not the case for prior art e.g. a metal tab or VG structure, and/or systems employing a semi-rigid adhesive system like an epoxy resin or similar. A metal tab is essentially crystalline and rigid at its surface and so cannot readily redistribute local bonding forces from across the adhesive interface, which means that once any local adhesive area exceeds the local adhesive force resisting capability, then a local surface rupture and hence bond failure will occur. These adhesive and joint stresses may be induced by; inertial, shock impact, varying aero/hydrodynamic forces, differences in material temperature and thermal expansion coefficients, material contamination, water freezing in associated small cracks, etc. In this inflexible joint condition, the local bond failure is not self-correcting so as to equalize local strain, and so a joint failure will progress from the location of lowest strength and/or maximum strain until the complete attachment surface fails. Flexible and/or plastic non-rigid materials are preferred for eLET body 8 along with adhesives that retain flexibility and joint force distribution. Buffer alignment strip 22 is a smaller structure, so may be less flexible material and applied in adjoining sections, so as to not induce high strains on the underlying surfaces with flexure and vibration.

There are a large range of flexible adhesives like; acrylics, polysulfides/polysufones, silicones, polyurethanes, vinyls, EPDM and natural rubbers etc., that can be paired with these new art aero/hydrodynamic elastomeric structures to yield the novel capabilities taught herein. A further refinement of elastomeric tabs, VG and CVG structures is to apply an e.g.; cast, sprayed or mold-formed or squeegeed/extruded or similar application of; flexible resin systems or material onto a substrate, and hence employ the material's internal homogenous self-bonding capability to also form the desired adhesive interface onto this clean and prepared flow control surface. In this combined eLET body 8 and adhesive 21 single part embodiment, the material is flexible and is configured as required after processing on the surface, to form the final new art aero/hydrodynamic shape or structure. This can be as effective as a combined elastomeric/adhesive system, but with lower ease of maintenance since removal and rework is more complex.

FIG. 3 is a wing top view looking forward into a slat slot 5 and shows an embodiment using a combination of elastomeric VG's (eVG's) optionally configured across this wing Slat slot so as to seal off any unwanted or disruptive slot leakage when the Slat is retracted in the cruise condition. In this case the unique capability of a formed elastomeric VG is to compress and become a seal in a retracted or closed Slat gap for improved cruise conditions and then expand back into a different functional form when the Slat is extended at low speeds. This embodiment contrasts with the turbulence and loss-causing prior art transverse Slat seal 106 and may be employed separately or in combination. An elastomeric VG shape is chosen because in the Slat-extended lower-speed case the high-energy slot airflow should suffer minimum flow blockage, and an eVG shape in the gap adds extra controlled beneficial vorticity to the energizing pressure-face fluid-flow; and so improves suction face flow attachment and allows a higher stall-AoA capability. Elastomeric VGs; as wing eVG 40 or slat eVG 41 can be formed with e.g.; square, T, L, F or U shapes and materials and attachment as variant of eLET body 8 art, and can both be angled to the freestream flow at about a 22 degree angle, or angled as required in the local flow conditions, so as to induce most efficient vortex generation. The size, locations and profiles of these eVG's are configured so that an effective flow seal TE eVG overlap 42 and LE eVG overlap 43 are formed by slight edge to edge eVG contact interference when the Slat is retracted and the slot gap is at a minimum. Depending on Slat gap geometry, the shed streamwise eVG 40 and 41 vortex filaments may be in close proximity and interact. An alternate embodiment avoiding this uses straight eVG 50 items on the slat attached along the freestream direction so they do not create significant vorticity, but still cooperate with the other angled eVG 40 vorticity generating set in an alternating array to seal the gap when in the cruise condition. Of course any of the buffer alignment strip methods may be added to these eVG embodiments. In the case of a SSTO type vehicle added eVG vorticity in a Slat gap analog allows a greater turning angle in the transition to suction face flows and slower approach and/or takeoff speeds for the delta wing or lifting body. The eLET body 8 may be formed from extrusions, or molded, bonded and machined to final sizes and shapes.

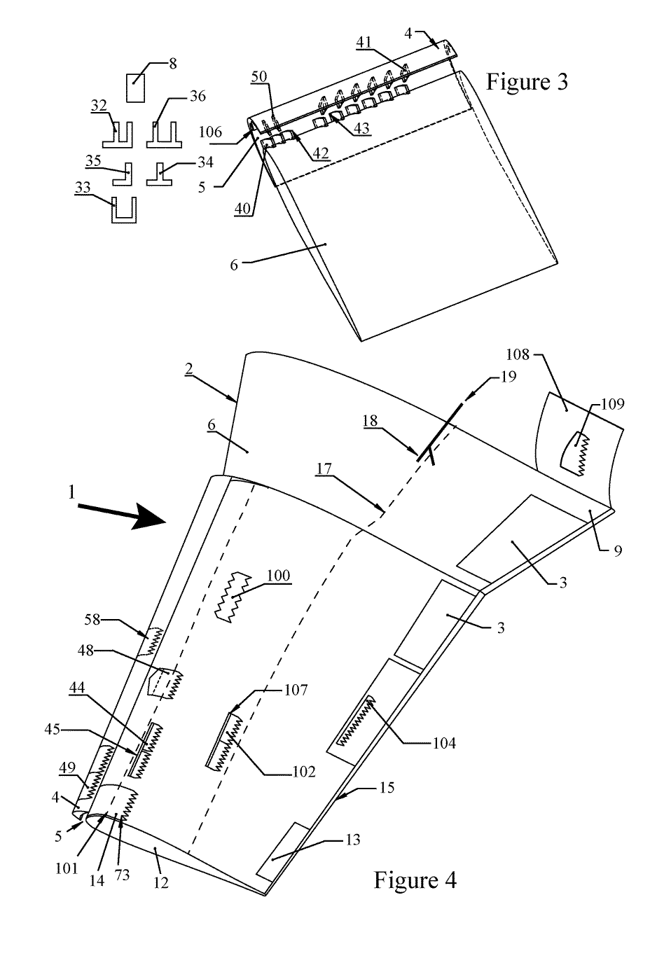

In transonic flight, highest cruise speeds are limited by sharply increasing Mach-shocks and wave-drag that effectively defines a wing-drag predominated Mcrit limitation. This non-linear drag increase is mostly driven by the wing suction face 6 (and to a lesser degree pressure face 7) normal-shocks which force an upset or detachment of the BL at the SBLI and representative Lambda-foot shock position. This dramatically increases shock and entropy/energy losses on the typically largest linear-dimension aerodynamic structure across the freestream flow. Clearly other control surface and structures like the fuselage, empennage etc., also enter flow shocks at other airspeeds defined by their flow geometry, and can also have losses usefully mitigated by this new art, but this wing embodiment is the focus of new art CVG application to mitigate wing shock losses as shown in FIG. 4.

Wrap CVG array 14 is shown that extends from the wing suction face 6 through the Slat slot 5 and onto the pressure face 7. This wrap CVG array 14 configuration (and/or other CVG) is optimized to generate intense and very persistent counter-rotating sub-BL streaming tip vortex-pairs from the incoming suction face freestream flows behind the Slat upper TE. These tip vorticies then impinge on the following suction face Lambda-foot shock 18 along shock line 17 and hence lower shock losses and/or wave drag at e.g. cruise conditions, when the Slat is retracted and the slot closed. The bend in shock line 17 points out that the wing section with Slat coverage disturbances tends to let the shock come forward due to the added BL stresses. The addition of CVG's drives the shock line 17 rearwards and the combination with eLET body 8 configured at the TE further improves shock mitigation and performance improvements. Top of shock 19 is indicated, and this is the limiting height from the flow surface and behind the LE that the displaced external freestream flow can experience acceleration to Mach1.0 due to the foil passage. Wrap CVG array 14 is placed further back from a typical CVG location on the Slat forward face (that would be optimized for a higher velocity freestream flow), and this is because an additional goal beyond shock loss mitigation is this CVG array is also employed to re-laminarize the Slat TE AFS disturbance and BL flow transition to turbulence. This is configured to thin the Slat downstream BL or momentum thickness, reduce Turbulent Kinetic Energy (TKE) generation and mitigate the excess drag caused by this Slat TE disturbance. On the pressure face, wrap CVG array 14 acts after the lower Slat TE flow disturbance in the same manner, and also mitigates the pressure face Lambda-foot shocks along shock line 10. For clarity only one or two sections of CVG's are shown in these figures, but it is to be understood that the embodiment is generally across a majority of the surface span(s) employing a number of CVG sections or elements as needed. These CVG elements essentially show an entry forward facing step that is angled to the freestream and these do not shed vorticity in the same way as an AFS.

On a wing with physically large or cumbersome Slat gap sizing, it is most convenient to assemble sections of a functional wrap CVG array 14 by using a number of shorter chordwise sections that are abutted in the spanwise direction with joints that allow a best outer surface continuity and surface BL flow. This effectively provides a wing LE wrap with the CVG pattern at the rearmost section TE's. In the spanwise direction, these groups of sections forming a wrap CVG array 14 are affixed adjacently and can be locally adjusted for mechanical clearances and attachments and local flow conditions, since along the span the chord changes dimension and the CVG's can be optimized for this. The spanwise Slat TE extent 101 dotted line on FIG. 4 wrap CVG array 14 shows where the slat TE comes to rest. CVG sections may be configured to be applied in different size groups but this is not limiting and the demarcation can be at multiple places and in any convenient geometry to allow alignment with items like interlocking joggles or features like a jigsaw puzzle teeth to help in alignment.

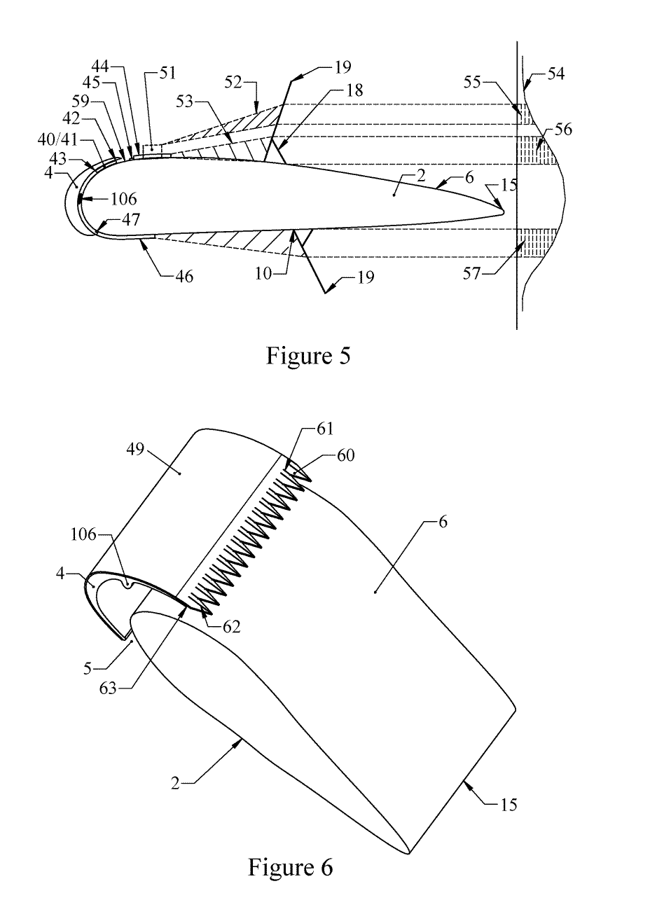

Since the Slat gap is often quite narrow, long, and the middle and lower sections may be crowded with actuation, control devices and access panels, in some embodiments it may not be practical to install and/or service some sections of wrap CVG array 14 through the Slat slot, as would be ideal. An alternate CVG embodiment is to employ a partial suction face CVG array 44 along with a partial pressure face CVG array 46 (also see FIG. 5). These partial CVG arrays 44 and 46 may be attached with a linear front entry edge that is at approximately right angles (transverse) to the freestream flow and will then generate a small low-loss LE transverse step-up vortex at this front step, similar to entry-vortex 25. As for the eLET attachment reliability, a suction CVG buffer alignment strip 45 and pressure CVG buffer alignment strip 47 can be added for mechanical integrity and adhesion protection. Partial suction face CVG array 44 may be partly shielded from the cruise velocity freestream fluid-flow by the Slat TE step and in fact can be configured with a setback from the Slat to generate a vortex channel 59 with a trapped spanwise channel vortex. Because of mechanical tolerances and movements it is not practical to abut CVG's directly and consistently exactly against the Slat TE with no entry flow disturbance, so in almost all cases there will be some form of transitional transverse gap or channel.

An additional CVG embodiment is to employ a partial suction face shock CVG array 102 along with a partial pressure face shock CVG array 103 with alignment buffer strips 107 and 105 respectively. These partial CVG's are located closer to the cruise shock foot and with the upstream CVG's improving the aft BL energy, there is additional BK organization possible to help improve losses. After the TE control surface start edges (e.g. flaps or spoilers) it is also possible to have control partial CVG array like 104.

A spanwise or transverse channel vortex or step-up vortex tends to have a circulation field that provides a slight down-force at the CVG entry surface-normal edge, and this does not tend to lift this entry edge, unless this has been disturbed mechanically and uplifted. CVG buffer alignment strip 45 and 47 (and others) are provided to protect and guard against this possibility of element LE detachment and are configured as for the eLET and eVG usage, being modified to account for thinner CVG geometry, and additionally provide a useful alignment edge when changing elastomeric elements. Since CVG's are applied in a series of abutting and convenient sized elements or sections, if a single section detaches unexpectedly, it is not catastrophic and the material loss is limited to the separated section. In front of e.g. an engine air intake, the attachment of the CVG would have to be a less convenient and more permanent type of material (such as metal) and/or adhesive. The application of CVG's in short sections also ensures that if a less flexible material such as metal, or a harder and less malleable material is used to fabricate the CVG, the underlying surface accrues a minimum of extra strain when flexing against these separated CVG sections, that have slight chordwise application tolerance and expansion gaps included between them to allow expansion and flexing of the underlying substrate or surface.

Set-forward partial CVG array 48 is an alternative embodiment, where a partial CVG array has its forward edge placed into the Slat slot 5 under and forward of the retracted Slat TE marked by the Slat TE extent 101 dotted line. This provides a non-channel form and minimum step change arrangement in the cruise configuration. This set-forward partial CVG array 48 element and combination of similar abutting elements is sized to correctly stream tip-vorticity into a following SBLI, and also may employ a forward buffer alignment strip arrangement to protect against material impacts through the extended Slat slot 5. Set-forward partial CVG array 48 element(s) and/or an associated matching alignment strip geometry may also be fabricated with, or incorporate an additional top layer of, low surface-energy material like e.g. PTFE around the area of Slat contact that can then act as a sacrificial rub, chafe prevention or anti-friction surface. This ensures that Slat contact on the prior wing surface paint does not cause damage, which otherwise allows surface corrosion to occur on the wing. The wing paint in this area may be then changed from the anti-friction type to higher energy paint that allows for better CVG adhesion. An anti-friction version of Set-forward partial CVG array 48 shown has an additional dotted line to indicate the variation of some forward portion as an anti-chafe feature and/or buffer alignment strip feature, and this leading edge has been provided with optional flow-angled sections that allow the incoming edge step vortices to flow to the side to discharge these vortex fluid flows in a manner that does not perturb the following CVG v-form step sections.

Any of these CVG elements may be fabricated in a transparent material that may have; manufacturing, batch, or part numbers, or any other fixed or variable display information reverse printed on the lower adhesive/attachment face. This may be installed, or additionally laminated onto a lower layer top-surface with any of the same types of display information; all of which will then be visible externally and protected from damage in operation.

Internal acoustic partial CVG array 58 may be placed before the inside TE of Slat 4 and is added to generate vorticity at the TE to improve flow mixing between Slat slot 5 flow and the freestream only when the slat is deployed, to reduce the acoustic signature due to this noisy slot fluid-flow region. Forward Slat LE CVG array 49 may also optionally and additionally be applied to the Slat outside LE to provide extra high-velocity BL energization, particularly at high AoA, approaching wing-stall with extended slats, and can be followed by any other CVG embodiments.

Curved fuselage panel 108 is shown adjacent to the wing root, but in fact it can be any surface or part of a cylindrical surface like a Sears-Haack body, exposed to the upstream freestream 1 that can be improved for shock and/or separation losses at high speed. Non-planar CVG array 109 is attached as shown at the correct orientation to the freestream with the v-tips producing intense downstream vortices to improve BL subject to shocks and disturbances such as flow interferences between these joined wing and fuselage bodies. The LE step of non-planar CVG array 109 is shown with a sweep angle to the freestream (like the wing CVGs) and this ensures the forward facing step vortex can discharge the step vortex filament and so be controlled in accumulation size to minimize entry losses. This example of non-planar CVG array 109 may be repeated as combinations of elements in series along and around the fuselage, or other bodies and can improve shock and separations around surface discontinuities like cockpit windows and doors etc. One of the greatest points of shock generation at high speed in a Newtonian fluid-flow on a Sears-Haack or similar cylindrical body like a; fuselage, tank, pod, projectile etc., is at the generally conical nose to cylindrical body transition blend or “brow”, where the bow shock, compressibility and flow transitions can help induce trailing normal and/or oblique shocks and turbulent separation as the flow accelerates around the body blending. Upstream instances of non-planar CVG array 109 may be attached to stream dense concentrations of tip vorticity to mitigate the lambda shock foot and lessens the flow losses and turbulence and acoustic noise generation. In a liquid medium the velocities are lower and compressibility shocks are replaced by flow separation, cavitation and turbulence.

Note that all combinations of CVG embodiment materials, sizes and configurations that perform the function(s) of; drag reduction, stall AoA extension, and flow separation improvements are considered as disclosed by this new art, and combinations of different embodiment types and numbers of these types of arrays may be chosen for any particular application. For a typical e.g. wing or flow control surface, a CVG step height of 0.25 mm to 5 mm (depending on flow speed and location) and a step length of 5 mm to 30 mm may be employed, and the optimized values then depend on testing at the design flow parameters such as; cruise Mach number, chord length, relative shock location distance and shock mitigation target chosen. For higher speed operation optimizing shock mitigation, a higher density of vortices (i.e. shorter step lengths) placed closer to the lambda-foot is chosen, and coverage of CVG sizes may be modified locally to be optimal at any application location. The nominal best CVG vorticity angle is typically about 22 degrees to local freestream flow and this can be modified locally to account for cross-flows, local flow changes etc., with the goal of creating greatest operating vorticity at lowest energy cost. Note that these typical parameters suggested are not limiting and the final determinant of any CVG embodiment is the correct generation of the novel beneficial effects to; mitigate shocks, reduce turbulence losses and reduce flow separations. The effect of CVG's also include the ability to desensitize the following BL to upstream flow perturbations like damage, dirt and other discontinuities.

Turbulator strip 100 is shown on the wing 2 suction face 6, and this prior art does not provide the performance improvements achieved by a CVG array. This is generally due to the fact that Turbulators are not optimized for streaming vorticity, but nominally BL turbulence generation, which the prior art practitioners consistently consider the prerequisite for improving BL attachment and loss control. Even though turbulators may be quite thin, the entry forward-facing steps and tips generate manifold entry fluid-flow patterns that interfere with their trailing edge aerodynamic flow effects (particularly with varying flow yaw), so it is almost impossible to reliably generate intense streaming vorticity to interact with a downstream SBLI or thin the downstream momentum layer thickness, and so reduce drag.

FIG. 5 shows a cross section of an improved configuration as an embodiment employing wing eVG array 40 or slat eVG array 41 in the overlap region with the Slat 4. These eVG devices are configured conforming to the wing/slat surface, are angled to the slot gap airflow to generate contra-rotating streaming vortices in the gap in the freestream direction, and have minimal or zero LE eVG overlap 43 or TE eVG overlap 42 between them at their upstream LE and downstream TE points respectively. These eVG array 40 devices are configured with sufficient exit height to generate strong vortices along the wing LE suction face curvature that additionally improves the wing flow separation resistance and increases wing stall AoA.

On the inside surface of Slat 4 the slat eVG 41 instances will generate a second set of co-rotating free-stream vortices in the opposite direction into the freestream flow on the opposite side of the slot gap and exit at the Slat TE. This Slat inner surface vorticity is not as beneficial to directly improve wing 2 flow-attachment or stall AoA capability. In the retracted case the Slat retracts closer to the wing and since the eVG array 40/41 devices are elastomeric they can be partly compressed in the remaining slot gap to provide a measure of sealing of slot gap air leakage in the cruise condition. When the Slat 4 is retracted the location of the two arrays wing eVG array 40 and slat eVG array 41 instances are configured to slightly overlap so a complete spanwise Slat seal is created. A slight interference or overlap wing eVG array 40 or slat eVG array 41 instance tips is possible and the elastomeric geometry and material can be e.g. tapered and configured geometrically at the ends to provide a consistent seal and effective VG operation in two of the distinct Slat operating states. This allows a fluid-flow improvement in different usage conditions or positions of the Slats.

Conventional or e.g. metal VG's cannot be placed into the slot gap because the clearances are not exact and/or predictable, and an over-height non-compliant VG will place undue stress on the retracting Slat and prevent proper stowage to the final stop points. Elastomeric Vortex Generator's 40/41 are configured by materials design, geometry and manufacturing to reliably compress with minimal force and restore fully to VG function in the Slat extended case. Accelerated airflows through the open Slat slot 5 can be high at takeoff and landing and transitions and it is an unexpected outcome that a typically lightweight elastomeric material can remain attached and minimally deflected in these flows of many hundreds of feet per second. This is due to the fact that an elastomeric material tends to equalize shear stresses along the attachment interfaces (typically some form of adhesive) and the vortex structures tend to support the upstream and downstream faces of the eVG array 40/41. Buffer alignment strips may also be employed to protect these eVG front edges, but this is not as critical as for devices that are subject to the cruise freestream flows.

A further embodiment is to provide only co-rotating streaming vortices on the wing 2 (versus the contra-rotating outcome in FIG. 3) it is possible to change e.g. all the inboard-pointing slat eVG array 41 instances to be aligned in the freestream direction as eVG 50 instances to generate no significant vorticity and place these in the required overlapping and sealing position on the inside face of the Slat 4. The remaining outboard-pointing wing eVG array 40 instances that are angled to freestream flow on the wing 2 will then stream co-rotating vortices along the wing 2 when the Slat slot 5 is open. Since these eVG instances now produce a co-1400 rotating and consistent flow vorticity (design-selectable in either vorticity direction) with no close by cancelling opposite flow, these can be configured to have an effect on the wing lift or total vorticity sum in either sense when the Slat is extended.

For new Slat designs the slot geometry and clearances can be configured for optimum sizes of wing eVG array 40 and slat eVG array 41. For existing Slat designs wing eVG array 40 and slat eVG array 41 are configured to allow retro-fit, and in some cases the inner slot surface of the Slat 4 may require the addition of a carrier surface to ensure the eVG arrays are correctly located in three dimensions. The wing 2 LE surface is typically smoothly contoured to allow wing eVG array 40 arrays to be retro-fitted. If the nominal Slat slot is too close, it is typically feasible to adjust the Slat retracted stop position to allow sufficient clearance for the wing eVG array 40 and slat eVG array 41 arrays to work correctly.

A prior art blade VG 51 is shown as dotted line on FIG. 5 wing cross section, and this streams prior-art vorticity 52 into the suction face normal shock above the shock Lambda-foot 18, 1415 because this design cannot stream vorticity closer to the foil surface. Item 54 shows the curve of typical momentum loss or entropy generation versus foil position immediately downstream of the foil TE, and item 55 is the summed area proportional to wave drag effects that the prior art blade VG 51 can help to alleviate. The highest entropy loss is close to the foil centerline due to foil drag and momentum losses and drops off either side until the foil has no effect on the external freestream or energy losses. This curve is qualitatively representational of the known physics and not quantitative in FIG. 5.

New art CVG vorticity 53 from partial suction face CVG array 44 is known to remain closely attached to the foil surface and streams through the strongest part of the shock Lambda-foot 18; which unmodified generates stronger entropy losses as the shock approaches the surface 1425 and/or the shock is intensified. This is an indication of why a CVG array is much more effective in reducing wave drag losses, as the relatively larger magnitude of summed loss area 56 indicates. The pressure face partial CVG array 46 is also active along to the shock foot location 10 and provides the loss improvement summed area 57, and this pressure face shock loss mitigation is not taught as this effective on shock losses on flight tested prior art wing embodiments.

FIG. 6 shows an alternate embodiment of a forward Slat LE CVG array 49 where a flexible after portion as CVG TE extension 60 is attached and brought back over and behind the Slat TE 63, with no adhesive behind the Slat TE 63 position. This allows the closed Slat to have an optimally located, selectively compliant and effective CVG trailing edge resting freely on the trailing wing surface, and the problematic Slat TE AFS discontinuity is bridged by a flexible film or membrane that can conform to the following wing surface and automatically follow the lowest-energy freestream configuration across the Slat TE AFS. Even though the Slat slot 5 is sealed when closed by e.g. transverse Slat seal 106, additional vent 61 through CVG TE extension 60 may be included to ensure no buildup of dynamic pressure differences, to keep this flexible film from being raised above the following wing surface with a closed slot. Hold-down compliance 62 means may be included which is an adhered array (or molded in) or attached linear spring-like device or material to add a fixed value of downwards alignment and compliant deflection and damping. This also ensures that CVG TE extension 60 acts correctly and is in a preferred essentially intimate contact with the following wing surface, as it deploys flexibly behind Slat TE 63 to a closed Slat position, and helps suppress vibration in the CVG membrane when the slat is extended.

In the low speed Slat-extended condition the natural slat opening and rotation condition holds the flexible CVG TE extension 60 above this now extended Slat slot 5 with an entrained accelerated fluid flow, and at the upper fluid-flow boundary these flexible CVG's act as freestream-located very low-height and drag off-surface vortex generators. These are configured and work very differently to e.g. Vijgen'665 and Balzer '106, since CVG TE extension 60 is significantly thinner membrane means, does not require a hinge means with actuator and incorporates; flexibility, device motion and compliance in more than one operating state, different geometry, turbulence mitigation across a closed mechanical Slat TE discontinuity, and/or effective downstream SBLI mitigation capability. The improved low drag VG action of flexible CVG's (even offset from a following surface) are not configured to change C_{L}, and allow for mixing of the two fluid-flows across any existing flow shear to reduce acoustic noise.

The new art CVG TE extension 60 geometry, material and fabrication ensures that this flexible CVG body and v-tips assume a balanced dynamic area force loading and so remain in damped minimal motion around a steady mean position and automatically track the lowest-energy freestream force-balanced configuration during the limited low-speed portion of flight with slats extended, unlike a Vijgen'665 rigid panel which is adjustably positioned by an external actuation means. The flexible CVG material and optional hold-down compliance 62 act to damp any flutter and the CVG materials are configurable as elastomeric or plastic combinations to be highly resistant to mechanical fatigue. Since FIG. 6 embodiment is for a non-rotating foil case, it is also possible to follow CVG TE extension 60 on the wing with following instances of partial suction face CVG array 44, wrap CVG array 14 or set-forward partial CVG array 48 that may extend further back for additional CVG surface activity, and also eVG array 40/41 devices that may be employed within the slot itself. CVG TE extension 60 may also be integrated into Slat LE CVG array 49 as a single application unit. The combination of low surface-energy CVG materials with low thermal resistance allows the anti-ice bleed-air or electrically heated slat to maintain an ice free state.

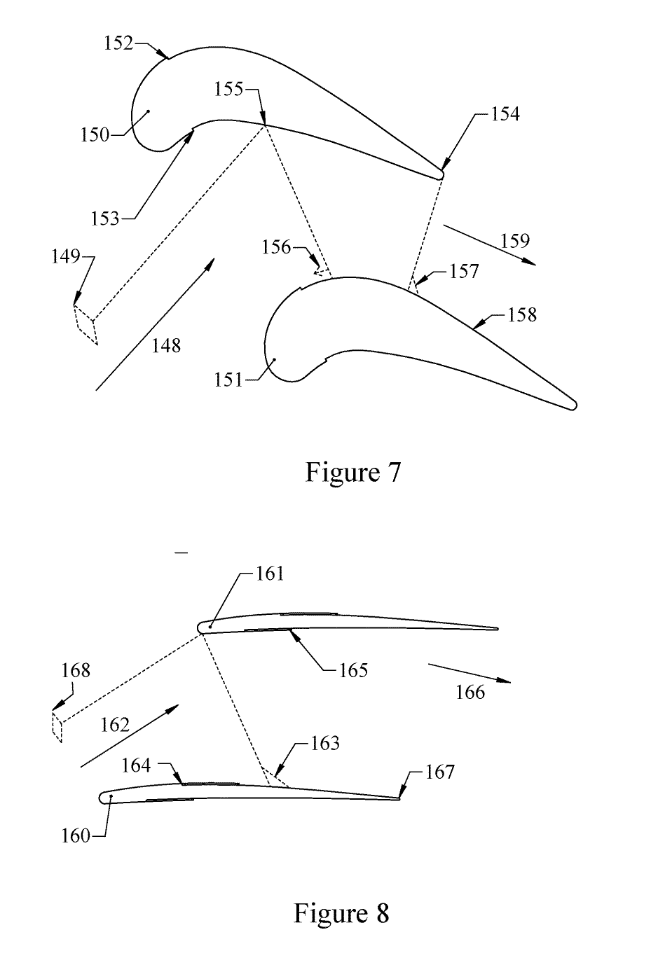

FIG. 7 shows turbine blade 150 and turbine blade 151 in a cascade with overlap set by disc solidity value, and the disc axis angled to the LE and TE alignment shown. The incoming turbine freestream flow 148 enters at the operating inlet flow angle and then exits as the turbine outlet freestream 159, after undergoing the blade turning angle and extracting work from the fluid-flow kinetic energy. Incoming upstream blade wake transient 149 enters at the inlet flow angle and meets the suction face of blade 150 at the impact point 155, and this disturbance is then effectively reflected back to impact the suction face of the second blade 151. At the impact point on blade 151 this reflected transient splits into an aft flowing positive jet influence; and forward flowing negative jet 156 influence that then acts to slow the incoming blade 151 BL and so induce turbulence and premature transition, which increase flow losses. The TE 154 influence as defining the geometric end of the blade passage overlap with turbine blade 151, induces a pressure transition and a TE shock 157 on the suction face of turbine blade 151 that causes separations and additional losses. The rear suction face 158 is affected by low Re conditions when the low energy and slowing BL separates, and this loss has been the primary focus of prior art turbine blade flow improvements which have focused on the blade rear after TE shock 157.

Suction face LE suction CVG array 152 on all the blades generate surface streaming tip vorticity on the blades that ensure that the suction BL is more fully energized from the CVG tips back to the blade TE 154, and this ensures that all the loss and separation mechanisms like; negative jet 156, TE shock 157, surface disruptions, premature bypass transition, Klebanoff streaks and low Re separation bubbles are mitigated, unlike the prior art. LE pressure CVG array 153 is configured on the blade pressure faces and the streaming tip vortices act to minimize Taylor-Gortler (TG) vortices flow loss and also help to disrupt the transient wakes at impact point 155. Both LE suction CVG array 152 and LE pressure CVG array 153 may be optionally fabricated with asymmetric CVG step lengths so as to sum a particular vorticity direction into the blade TE and hence influence the TE exit flow conditions and total blade lift. FIG. 8 shows compressor blade 160 and compressor blade 161 in a cascade. The stagger of the blades LE's is opposite for the turbine cascade example in FIG. 7 since this compressor cascade is designed to induce velocity in a fluid-flow; and so the blade angles are effectively reversed and the cascade imparts energy to the fluid-flows. Incoming compressor freestream flow 162 enters at the operating inlet flow incidence angle and then exits as the compressor outlet freestream 166, after undergoing the blade turning angle and increasing the fluid-flow kinetic energy. Incoming compressor blade wake transient 168 enters at the inlet flow angle and meets the LE of blade 161 and is partially reflected back to blade 160. Compressor shock line 163 on the suction face is due to the influence of the adjacent blade 161, and since the fluid-flow is not generally accelerating in the passage overlap after the initial LE acceleration, the compressor blade suction face separation is a primary performance limiting condition that can lead to; local blade stalling, synchronous blade passage stall cells, flow breakdown and compressor surge.

Compressor LE suction CVG array 164 is added to all the blade suction sides and streams tip vorticity into the compressor shock line 163 to lower the shock losses and separations, as well as generally improving the blade suction face BL energy, and allowing a larger designed compressor turning angle before discharge into a downstream diffusing stator set that induces pressure recovery into the slowing fluid flow. Compressor LE pressure CVG array 165 is added to all the blade pressure faces and streams tip vorticity along the blade pressure face to minimize flow losses and TG vortices, and also allow a greater blade turning capability, allowing axial compressor designs with fewer stages and lower weight and costs. As for the turbine blade, the compressor CVG arrays may be optionally fabricated with asymmetric CVG step lengths so as to sum a particular vorticity direction into the blade TE and hence influence the TE exit flow conditions and total blade lift. These CVG general arrangements herein are taught in the parent application that is incorporated by reference. Shock mitigation by CVG's taught here is applicable and configurable for fluid-flow shocks on a; wing, nacelle, fuselage, bypass-fan, compressor, rotor foil, stator foil, propeller, fluid-flow ducting, combustor or a turbine.

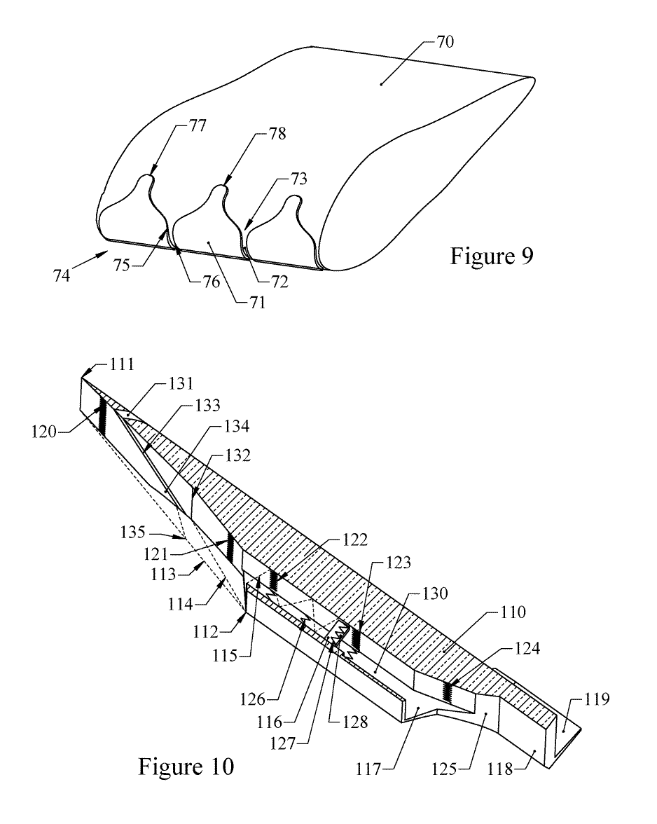

FIG. 9 shows a foil section 70 that is configured with interrupted CVG 71 instances at the LE so as to improve a deep dynamic stall Cm condition. Induction groove 72 is configured as being surrounded by steps with varying local angles so the high velocity LE local freestream local fluid-flow direction 74 in the LE BL region crossing this groove at an angle forms an up-flow travelling step vortex 75 over an AFS which then continues rearwards as for any CVG in e.g. FIG. 4. In this case there is no forward CVG valley 73 located behind the TE and in fact the left side of induction groove 72 is configured so that a portion of the fluid flow on the suction side of the LE stagnation point is intercepted and streamed back to interrupted CVG tip 77 to then stream as half of an intense sub-BL streamwise contra-rotating vortex filament pair. On the right or “down-flow” area of induction groove 72 the fluid-flow crosses this now down-flow partially forward-facing step 76 and also produces a step vortex that will travel rearwards and carry off vortex fluid-flow and momentum to the second interrupted CVG tip 78. These two step flows are retained over a wide range of foil AoA, and in the deep dynamic stall condition allows fluid flow to continue around the LE on the suction face and then stream back as a partial CVG streaming vortex effect, and help to break up the strong spanwise LE vortex suction that leads to the deep dynamic-stall high Cm condition. For normal non-dynamic stall or unstalled AoA operation the fluid flows operate as for an e.g. FIG. 4 CVG, and induction groove 72 operates as an upstream form of CVG valley 73 and the rearward CVG step sections operate as before. In this case there is no interrupted CVG material to protect the LE of the foil in CVG valley 73, so these CVG structure arrays would be placed on a sub-layer of material that can provide e.g. erosion protection etc. The edge shape and geometry of induction groove 72 is dictated by the local LE flow, and on a helicopter or swept wing a significant cross-flow to the local freestream local fluid-flow direction 74 is present and is taken into account in the design.

Other LE modification technologies have been attempted like the bio-inspired Blue-whale pectoral fin LE Tubercule, such as Pankl Aerospace Inc. has mimicked on sculpted helicopter rotor blades, or the DLR “LEVogs” that place a turbulence generator around the blade LE stagnation point. Both of these LE modifiers are not very effective at improving deep dynamic stall and shock loss and drag reductions are not in the range possible with CVG's.

FIG. 10 shows a cross sectioned oblique view of a US National Spaceplane type civil hypersonic scramjet powered partially air-breathing vehicle, so features are more easily seen. The vehicle body 110 has a high speed aerodynamically sharp body leading edge 111 that forms a strong bow oblique shock 113 at hypersonic speeds that surrounds the whole vehicle and is partly employed as the first compression shock to slow down impinging rarefied atmosphere and help direct it via a fore-body shock ramp 132 and its reflected second shock 114 to the scramjet inlet lip 112 for processing.

This Waverider type body with vertical stabilizer 119 is designed to operate from low Mach numbers at takeoff from conventional horizontal runways and accelerate thru transonic flight and on to high supersonic speed (˜Mach 4+) employing a combined-cycle engine method based on e.g. an internal Turbofan engine etc., as well as a scramjet at higher speeds.

Above M4.0 a scramjet compression inlet may be ‘started’ to enable hypersonic flight regimes, where the scramjet can now be employed for thrust. At takeoff at about ˜M0.25 the body operates as a partial delta-winged aircraft, and lift at low speed moderate angle of attack (AoA) regimes in the dense lower atmosphere is provided by upper LE suction-face vortices of the delta wing and some body dynamic bottom face positive pressure. At high speed (e.g. ˜M4 to M9+) and/or lower AoA the vehicle typically operates as a Waverider type of vehicle using mostly bottom surface dynamic impact pressures to generate balancing lift force. At hypersonic speeds this civilian NASP vehicle can follow a flight path that allows atmospheric exit and use a combined-cycle jet engine/rocket mode to accelerate to Low Earth Orbit (LEO) as an SSTO vehicle, or skip across the top of the e.g. stratosphere and be a sub-orbital high speed civil transport.

An equivalent type of angled delta Slat slot 131 can be provided for low speed enhanced lift operation that opens a path to allow selective fluid-flow from the underside pressure face into the central portion of the suction face. EVG's as for a regular Slat slot exit as in FIG. 3 are added on the rear exit slat slot face, and these perform the; Slat slot sealing and fluid-flow attachment functionality since they are not subjected to high speed hot fluid-flows. Delta Slat slot 131 is shown as angled from the centerline along slot edge line 133 and terminates before the swept LE sections that have the low speed vortex lifting sections on the top surface (not shown).

Scramjet engine 117 is configured as a duct system, with an initial isolator section that processes the initial lip oblique shock 115 and further reflects multiple compression shocks down this isolator section to slow down and compress the fluid flow to near sonic speeds upon reaching the vicinity of fuel injection pylon 116. After fuel is added into a compressed and near sonic flow, combustion occurs in the rear of the duct in the combustor section 130 and then the exhaust fluid flow is expanded and accelerated by the aft body expansion surface 125, and the fuel enthalpy is released that provides energy to overcome the vehicle entropy losses and sustain speed.

After scramj et inlet starting a major challenge is to maintain flow stability in the cascaded and interrelated hypersonic-supersonic-transonic flows. The isolator and combustor sections are limited in flow capacity by thermal flow choking and additionally any BL flow separations in these sections. Correct isolator operation as supersonic flow ensures that any pressure changes in the downstream and combustor sections are not transmitted upstream to cause problems with the inlet conditions. If the downstream section flows drop below Mach 1.0 then a terminal normal shock is present and the subsequent flows interact because pressure perturbations can flow in any direction.

Because the isolator and combustor walls have BL flows with the closest wall portion below the sonic line, this presents a thin channel by which downstream pressure changes and flow state information will “leak back” up the isolator section. In particular the isolator oblique shocks all interact with the surface BL and induce uncontrolled SWBLI separations when the shocks are strong. This causes the effective duct cross section to decrease and tend to cross-section flow choking, and it is possible for these flow perturbations to cascade back up this otherwise isolated volume and cause the ideal “shock on lip” inlet conditions to change adversely. This feedback cycle can be unstable, hysteretic and lead to inlet unstart and/or engine damage. To stabilize the isolator and combustor BL duct flows, isolator entry CVG array 122 and combustor entry CVG array 123 and side wall CVG array 126 are added around the duct walls and these are configured ahead of the nominal design shock locations to help suppress the shock induced BL separations, and are configured in size and height as acting mostly below the sonic line of the BL. Since the velocity and shock profiles change with vehicle speed, it is possible to have a number of cascaded CVG arrays on the duct walls that help control SWBLI over a predetermined duct section irrespective a of exact shock locations, so that the ducting is desensitized to fluid flow velocity changes that occur naturally in operation, so flow choking is then mainly limited by thermal effects.

Inlet turn CVG array 121 is provided before the upper edge of the inlet to provide BL stabilization on the transition from the fore-body shock ramp 132 into the isolator ducting to ensure separation free BL at this transition, whether sharp edged or a curved surface. By having multiple CVG arrays around the whole duct section wall circumference the problem with rectilinear or round duct corners of flow separation roll-over, slewing and detachment is eliminated.

Fuel injection pylon 116 may employ a pylon mixing CVG array 127 to add controlled intense mixing vorticity adjacent to fuel injection port 128 to improve combustion speed and uniformity without adding significant drag. As an alternative to the flow-disrupting fuel injection pylon 116 it is possible to modify combustor entry CVG array 123 with an increased step height and with fuel injection ports (as for the removed pylon) that then efficiently mix in the fuel along the CVG rear facing step edge and support combustion. The CVG step edge stagnation points below the BL sonic line allow flame-holding to occur to stabilize combustion. Combustor exit CVG array 124 is provided to help stabilize the exiting flow BL across aft body expansion surface 125 and onto the final exit face 118 at the final freestream velocity and ambient pressures. A leading edge CVG array 120 may be added near the body leading edge 111 to stabilize the early BL development and may also employ gas injection ports behind the CVG array steps to allow addition of BL cooling or modifying gasses such as carbon monoxide to change local flow density or introduce pre-combustion gases initially below the sonic line that flow down the ramp surface and into the engine inlet duct. Slot edge line 133 present an angled surface discontinuity that may generate a weak oblique shock that propagates to meet the bow oblique shock 113 at meeting point 135 as an Edney class VI shock interaction that slightly modifies this bow shock geometry.

The initial slot edge may be expanded as a larger groove to generate a larger travelling edge vortex-flow along the slot edge with a larger mass of fluid-flow entrained and so increase the related oblique shock and its effect on the bow shock position. The vortex flow along Slot edge line 133 may be rapidly varied by flow modulator 134 means which may be implemented by a vortex transverse; mechanical flow gating device, a gas injection device or a plasma actuator that acts to control the vortex and its size and hence level of shock generation. This provides a fast and fine trimming method for ensuring the “shock on inlet” flow condition.

These surprisingly diverse ranges of types of embodiments as taught herein to improve drag by shock loss mitigation, and device fluid-flow and energy efficiency improvements are an unexpected outcome and capability of fundamentally integrated CVG and eVG applications that are simply not practical or possible with conventional prior art Vortex Generator or flow control approaches. All the cited embodiments and variations, and extensions to cover varying application instances and areas, at their most fundamental common level, employ novel configurations of Conformal Vortex Generator art and/or eVG art to process or manipulate Newtonian fluid-flows to obtain a level of benefits such as improved energy efficiency and/or expanded control ranges, not possible with prior art.

Therefore, while the disclosed information details the preferred embodiments of the invention, no material limitations to the scope of the claimed invention are intended and any features and alternative designs that would be obvious to one of ordinary skill in the art are considered to be incorporated herein. Consequently, rather than being limited strictly to the features disclosed with regard to the preferred embodiment, the scope of the invention is set forth and particularly described in the following attached claims.

What is claimed is:

1. A method applied to an aero/hydrodynamic surface employed to modify a Newtonian fluid-flow, so as to mitigate a shock loss and/or lower the viscous drag on a downstream surface, comprising:
(i) said aero/hydrodynamic surface employed to modify a Newtonian fluid-flow with the addition of,
(ii) at least one conformal vortex generator means that is configured with flow-angled aft facing steps to generate sub-boundary layer streaming vortices from rear pointing tip locations in the local freestream direction onto said downstream surface, and that is configured for shock interaction effectiveness,
whereby application of said conformal vortex generator means reduces shock loss and/or improves viscous drag on a downstream surface.

2. The method defined in claim 1 wherein said conformal vortex generator means is integrated into the design of said aero/hydrodynamic surface allowing improved operating capability.

3. The method defined in claim 2 wherein said conformal vortex generator means is integral to and configured during the design and/or testing process of said aero/hydrodynamic surface to reduce shock loss.

4. The method defined in claim 1 wherein said conformal vortex generator means is configured upon said existing aero/hydrodynamic surface to reduce shock loss and viscous drag.

5. The method defined in claim 4 wherein said integrated conformal vortex generator is configured during a testing process of operating said aero/hydrodynamic surface to reduce shock losses and viscous drag.

6. The methods of claim 3 and claim 5 where said aero/hydrodynamic surface is a foil operating in a gaseous Newtonian fluid-flow.

7. The method of claim 6 where said foil is a is a member of the group comprising; a wing means, a bypass-fan means, a compressor blade means, a rotor foil means, a stator foil means, a propeller blade means, a fluid-flow ducting means, a combustor surface means or a turbine blade means, and employs at least one said conformal vortex generator means on said aero/hydrodynamic surface to reduce shock losses and viscous drag.

8. The method of claim 7 wherein said wing means is configured with a leading edge Slat lift-enhancing means.

9. The method of claim 8 wherein said conformal vortex generator means is configured on a suction surface behind said leading edge Slat lift enhancing means.

10. The method of claim 9 wherein said conformal vortex generator means configured on a suction surface behind said leading edge Slat lift enhancing means is attached such that it is replaceable for maintenance and is protected from leading edge damage and/or detachment by a buffer alignment strip means.

11. The method of claim 10 wherein said buffer alignment strip means provides a permanent method to align said conformal vortex generator during a maintenance process.

12. The method of claim 1 wherein said conformal vortex generator means is configured to generate vortex filaments that act to modify acoustic wave propagation to suppress generated noise.

13. The method of claim 1 wherein said conformal vortex generator means is modified with a leading edge induction groove to improve flow attachment in deep dynamic stall conditions and/or lower the foil pitching moment.

14. The method of claim 1 wherein said conformal vortex generator means is applied on a wing means modified with the combination of a trailing edge elastomeric lift enhancing tab means to further move a shock rearwards on the foil surface and enhance shock loss improvements.

15. The method of claim 9 wherein said conformal vortex generator means configured on a suction surface behind said leading edge Slat lift enhancing means is followed by a second instance of conformal vortex generator means closer to a shock to improve boundary layer energy and shock mitigation.

16. The method of claim 9 wherein said conformal vortex generator means configured on a suction surface behind said leading edge Slat lift enhancing means is extended underneath said leading edge Slat lift enhancing means to a pressure face location.

17. The method of claim 16 wherein extended said conformal vortex generator means is configured with a low surface-energy material surface presented to said leading edge Slat lift enhancing means to provide a friction lowering and/or abrasion resistance capability.

18. The method of claim 14 wherein trailing edge elastomeric lift enhancing tab means has the addition of a buffer alignment strip means to provide a permanent method to align said conformal vortex generator during a maintenance process.

19. The method of claim 14 wherein trailing edge elastomeric lift enhancing tab means has the addition of buffer alignment strip means to protect an adhesion interface.

20. The method of claim 8 wherein said a leading edge Slat lift-enhancing means is modified by addition of elastomeric vortex generators in the slat gap to create a gap seal when retracted and thus lower cruise condition losses.

21. The method of claim 8 wherein said a leading edge Slat lift-enhancing means is modified by addition of elastomeric vortex generators in the slat gap to create vortices that enhance lift when the slat is extended.

22. The method of claim 8 wherein said leading edge Slat lift-enhancing means is modified by addition of a flexible trailing edge extension with a configured conformal vortex generator means that further acts as a compliant bridge across a trailing edge gap to a following wing surface to minimize losses when said leading edge Slat lift-enhancing means is retracted.

23. The method of claim 7 wherein said wing means employing said conformal vortex generator is configured by removal of existing blade vortex generators to lower drag, whilst maintaining required vortex action for shock interaction.

24. The method of claim 7 wherein said propeller blade means, employing said conformal vortex generator, is configured without requiring blade sweep to mitigate shock losses.

25. The method of claim 7 wherein said wing means employing said conformal vortex generator is configured to increase a critical mach number to allow higher speed operation.

26. The method of claim 3 wherein said conformal vortex generator is configured on a cylindrical Sears-Haack body or equivalent configuration body to lower shock losses.

27. The method of claim 26 wherein said cylindrical Sears-Haack body or equivalent configuration body is an aircraft fuselage.

28. A Newtonian fluid-flow aero/hydrodynamic processing apparatus employed to modify a Newtonian fluid-flow, so as to mitigate a shock loss and/or lower the viscous drag on a downstream surface, comprising:
(i) said aero/hydrodynamic surface employed to modify a Newtonian fluid-flow with the addition of,
(ii) at least one conformal vortex generator that is configured with flow-angled aft facing steps to generate sub-boundary layer streaming vortices from rear pointing tip locations in the local freestream direction onto said downstream surface, and that is configured for shock interaction effectiveness,
whereby application of said conformal vortex generator reduces shock loss and/or improves viscous drag on a downstream surface.

29. The apparatus defined in claim 28 wherein said conformal vortex generator is an integrated conformal vortex generator that is integrally embedded in said aero/hydrodynamic surface.

30. The apparatus defined in claim 28 wherein said conformal vortex generator is configured to generate vortex filaments that act to modify acoustic wave propagation to suppress generated noise.
